(19) United States
(12) Patent Application Publication
(10) Pub. No.: US 2011/0093356 A1
(43) Pub. Date: Apr. 21, 2011

(54) COST ESTIMATION SYSTEMS, METHODS, AND USER INTERFACES FOR CONFIGURABLE ELECTRICAL PANELS

(76) Inventors: Brian Corey Hall, St. Peters, MO (US); Joseph James Ventura, Eureka, MO (US)

(21) Appl. No.: 12/904,466

(22) Filed: Oct. 14, 2010

Related U.S. Application Data
(60) Provisional application No. 61/253,642, filed on Oct. 21, 2009.

(51) Int. Cl. G06Q 30/00

(52) U.S. Cl. 705/26.4

(57) ABSTRACT

Computer implemented systems, methods and user interfaces facilitate a nearly instantaneous ability to provide detailed cost estimate information and price quotes for complex and highly configurable products tailored to meet user defined specifications such as electrical control panels for electrical power systems.

### CROSS REFERENCE TO RELATED APPLICATIONS

This application claims the benefit of U.S. Provisional Application Ser. No. 61/253,642 filed Oct. 21, 2009, the disclosure of which is hereby incorporated by reference in its entirety.

This application also relates in part to subject matter disclosed in commonly owned U.S. patent application Ser. Nos. 12/691,344 filed Jan. 21, 2010 and 11/941,212 filed Nov. 16, 2007, the disclosures of which is hereby incorporated by reference in their entirety.

This application also relates in part to subject matter disclosed in commonly owned U.S. patent application Ser. No. 11/622,526 filed Jan. 12, 2007, now issued U.S. Pat. No. 7,779,371, which claims the benefit of U.S. Provisional Application Ser. No. 60/859,264 filed Nov. 26, 2006, the complete disclosures of which are hereby incorporated by reference in their entirety.

### BACKGROUND OF THE INVENTION

The field of the invention relates generally to electrical systems and products that are configurable to user-defined specifications in a customized manner, and more specifically to electronic systems and methods for providing cost estimate information for configurable products such as electrical control panels.

Electrical power circuitry and associated components can be rather complex in configuration and generally adaptable to meet the particular needs of an electrical system operator. For example, industrial facilities typically include a number of electrical control panels distributed in various locations throughout an industrial facility. Each control panel interconnects various portions of electrical circuitry making up the larger electrical system, and each control panel includes specific circuit components, including but not limited to circuit protection components such as fuses, circuit breakers, and switches.

The particular type of circuit protection components in each panel may vary from panel to panel, and typically a large variety of circuit protection components are available to electrical system installers and maintenance personnel for use in any given panel. To ensure flexibility to system designers and service personnel, the electrical panels are highly configurable to accommodate the needs of particular applications. That is, the panels may accommodate various combinations of circuit components, including but not limited to circuit protection components, so that the panels may be more or less custom tailored to meet specific needs at particular locations in the larger electrical system. Many different combinations of circuits and circuit components are typically possible in any given electrical panel, with resultant large cost variations for different choices of circuit components.

The rather extensive configurability of electrical panels presents practical challenges to electrical panel providers as well as purchasers. In particular, and because of the high degree of configurability of the panels to provide more or less customized panels to specific users, pricing electrical control panels has conventionally been a tedious, error prone process, and improvements are desired.

### BRIEF DESCRIPTION OF THE DRAWINGS

Non-limiting and non-exhaustive embodiments are described with reference to the following Figures, wherein like reference numerals refer to like parts throughout the various views unless otherwise specified.

FIG. 1 is a schematic diagram of a portion of an exemplary electrical panel.

FIG. 2 is a simplified block diagram of an exemplary embodiment of an interactive computer-implemented system for providing price information for a customized electrical panel.

FIG. 3 is an expanded block diagram of an exemplary embodiment of a server architecture of the system shown in FIG. 1.

FIGS. 4-7 illustrate exemplary embodiments of a user interface for the system shown in FIGS. 2 and 3, wherein:

FIG. 4 is an example embodiment of a user interface displaying a project screen for a user of the system;

FIG. 5 is an example of a user interface displaying a project export screen for a user of the system;

FIG. 6 is an example of a project cost quote screen for a user of the system; and

FIG. 7 is an example of a project configuration screen for a user of the system.

FIG. 8 is an exemplary approval drawing generated by the system for an exemplary electrical panel.

FIG. 9 is an exemplary bill of material and pricing quote generated by the system for the exemplary electrical panel.

FIG. 10 illustrates an exemplary supply circuit connection data entry processing algorithm.

FIG. 11 illustrates an exemplary feeder circuit data entry processing algorithm.

FIG. 12 illustrates an exemplary sub-feeder circuit connection data entry processing algorithm.

FIG. 13 illustrates an exemplary navigation logic, display and reporting processing algorithm.

FIG. 14 illustrates an exemplary engineering logic algorithm.

FIG. 15 illustrates an exemplary cost and availability algorithm for a configured product.

### DETAILED DESCRIPTION OF THE INVENTION

Exemplary embodiments of methods and systems are disclosed herein that overcome problems, difficulties and disadvantages discussed below for analyzing, for example, configurable and customizable electrical control panels and providing quick and accurate prices quotes and cost estimates to a purchaser for customized panel configurations. This is achieved at least in part with the provision of interactive web-based systems and methods for pricing complex electrical panel designs. Data and information related to the configurable panel options are archived in the system databases, and with an intuitive menu driven user interface and graphic displays, interested users may rather quickly obtain reliable price estimates. Human error in the data entry and price analysis is largely, if not completely avoided. Real time price analysis feedback may be made available, permitting users to more readily understand the impact of design changes on panel price. The price information and feedback is available in summary form and in a detailed form for study by system users.

In order to appreciate the invention to its fullest extent, the following disclosure will be divided into different parts or segments, wherein Part I discusses particular problems of providing cost estimates for rather complex electrical panels; and Part II discloses exemplary systems, processes and user interfaces for analyzing and evaluating cost information for the complex electrical panels discussed in Part I.

### I. Introduction to the Invention

Products that are highly customized for particular end users and user-defined specifications, referred to herein as “configurable products” are not subject to commodity pricing, as specifically contrasted with substantially identical, mass produced products conforming to generally applicable specifications. That is, the cost of such configurable products may vary considerably depending on the complexity of the product, the particular options selected by a purchaser, or the demands of user-provided specifications and requirements for the performance of the product. Furthermore, for rather complex products having a relatively large number of components arranged in numerous possible combinations to meet the user-provided specifications, they tend to be expensive in comparison to mass produced and highly standardized products. Because of the expense and variability of such configurable products, it has become customary for purchasers to request detailed cost estimates from configurable product providers and suppliers in advance of purchase. Experience has shown, however, that practical challenges exist to complex configurable product suppliers in determining timely and accurate price information and estimates in an efficient manner.

One exemplary type of complex, configurable product in which such challenges are notable is the manufacture and assembly of electrical control panels for electrical power systems. Industrial motors, machines, and HVAC equipment for example, typically are provided with electrical control panels that regulate electrical power thereto to meet specific needs that are highly user dependent. That is, the electrical control panels in an electrical power system may vary considerably in their complexity and performance requirements depending on the specific line and load side connections made to each specific panel. For the same reason, the electrical control panels tend to be custom designed for specific locations in specific electrical power systems. Different voltage, current and other electrical conditions may apply, and different circuit protection issues may be presented in each panel. As such, the unique electrical specifications are typically defined for each panel to meet for a particular installation, and the panel is then configured with the appropriate circuits and components to meet the specifications.

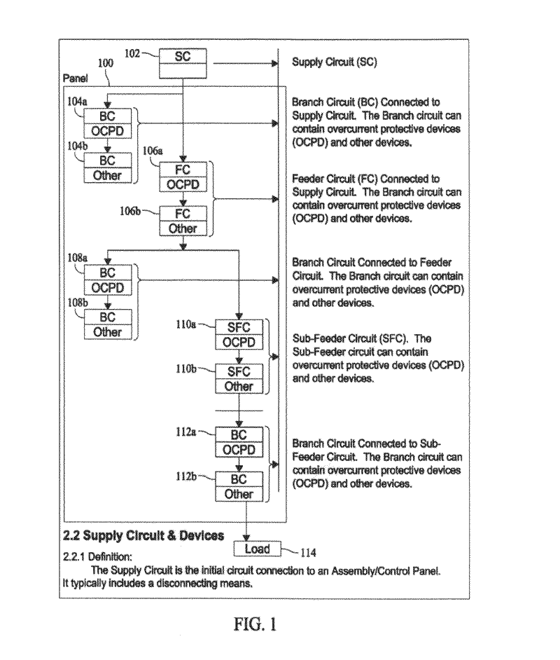

FIG. 1 is a schematic diagram of an exemplary electrical control panel 100, in which the challenges of timely and accurately configuring the electrical panel and providing a reliable cost estimate for the panel are believed to be demonstrated. The panel 100 is connected to a power supply 102 and includes control circuitry, described below, including protective devices to prevent damage to associated electrical loads in electrical fault conditions, which may include short-circuit current conditions, overcurrent conditions, and overvoltage conditions. The protective devices may include fuses, limiters, breakers, surge suppressors and other known devices. Such a panel 100 can itself be rather complex in its number of circuits, devices connected in the circuits, and the functional relationship of the interconnected devices. As the number of interconnected circuits and associated circuit components or circuit devices in any given control panel increases, so do practical challenges in analyzing the cost of such a panel in a timely and efficient manner.

As shown in FIG. 1, a power supply circuit (“SC”) 102 is the initial current circuit connection to the control panel 100. Within the panel 100 are one or more branch circuits 104 connected to the supply circuit 102, one or more feeder circuits 106 connected to the supply circuit 102 and/or the branch circuits 104, one or more branch circuits 108 connected to the feeder circuits 106, one or more sub-feeder circuits 110 connected to the feeder circuits 106 and/or the branch circuits 108, and one or more branch circuits 112 connected to the sub-feeder circuits 110. The branch circuits 112 are, in turn, connected to one or more loads 114. The control panel 100, via the circuits 104, 106, 108, 110 and 112 regulates power from the supply circuit 102 to the loads 114, and among other things regulates current flow to the electrical loads 114 to protect them from potentially damaging short circuit conditions, as well as other potential electrical fault conditions.

The number of branch circuits 104, feeder circuits 106, branch circuits 108 connected to feeder circuits, sub-feeder circuits 110 and branch circuits 112 connected to sub-feeder may each be relatively large in number, such as about ten, in different exemplary embodiments of the panel 100. In different embodiments, the panel 100 may be assembled with all its circuits and sold as an integral pre-packaged product for a particular load or loads 114, or the panel 100 may alternatively be assembled on site or constructed in a custom manner to meet the needs of a particular load or loads 114. Regardless, the end purchaser will no doubt want a detailed cost estimate for the panel 100 prior to its purchase. After all, the panel 100 must not only meet performance requirements when installed, but must not exceed cost constraints for a particular project.

Not only may the panel 100 entail a large number of circuit devices, but it may include a large number of different types of devices that each may affect the operation and cost of the panel as a whole. The power supply circuit 102 represents the first incoming circuit that is connected to the panel 100, and the components in the supply circuit 102 may affect, for example, the short-circuit current rating of the panel 100 in use, which may in turn be one of the defined specifications for the panel. In different embodiments, the supply circuit 102 may include a disconnect switch or switching mechanism. More specifically, two basic types of supply circuits are conventionally provided for powering electrical control panels such as the panel 100, namely a disconnecting means coupled to a circuit protector such as an overcurrent protector, or a disconnecting means without a circuit protector, including but not limited to a remote disconnector.

The panel 100 may also include one or more branch circuits 104 connected to the power supply circuit 102. The branch circuits 104 may contain protective devices such as overcurrent protection devices designated in portion 104a, and other devices designated in the portion 104b.

Additionally, the panel 100 may include a feeder circuit or circuits 106 connected to the power supply circuit 102, and the feeder circuit 106 may include protective devices such as overcurrent protection devices designated in portion 106a, and other devices designated in the portion 106b. The feeder circuit 106 represents the next level of circuit connection to the panel 100 after the supply circuit 102, and the feeder circuits may include devices connected on the supply side of the branch circuit overcurrent protection device designated in portion 104a.

The panel 100 may also include one or more branch circuits 108 connected to the feeder circuits 106, and the branch circuits 108 may include protective devices such as overcurrent protection devices designated in portion 108a, and other devices designated in the portion 108b.

Sub-feeder circuits 110 may also be provided in the panel 100 and may be connected to the feeder circuits 106. The sub-feeder circuits 110 may include protective devices such overcurrent protection devices designated in portion 110a, and other devices designated in the portion 110b. The sub-feeder circuits 100 may be considered similar to the feeder circuits 106 and are the next level of feeder circuits connected to the panel 100. The sub-feeder circuits 110 may include devices that are connected on the supply side of the branch circuit overcurrent protection device 108a.

Branch circuits 112 may be provided in the panel 100 and connected to the sub-feeder circuits 110. The branch circuits 112 may include protective devices such overcurrent protection devices designated in portion 112a and or other devices designated in the portion 112b. The branch circuits 112 are the final or lowest level of circuits closest to the loads 114 associated with the panel 100, such as a motor, a machine or HVAC equipment as several examples. The branch circuits 112 may include devices that are connected from the last overcurrent protection device in the panel 100 to the load 114. In other words, the branch circuits 112 include the conductors and components following the last overcurrent protection device protecting a load associated with the panel 100.

A variety of components may be utilized in the circuitry in the panel 100. As previously mentioned, two types of supply circuits are predominately used in supply circuits, namely a supply circuit having disconnecting means with overcurrent protection, or a remote disconnecting means or disconnecting means without overcurrent protection. As used herein, a supply circuit type of “disconnecting means without overcurrent protection” shall refer to a circuit terminating in a device that provides both a disconnecting means and an overcurrent protection device, such as a fused disconnect switch or circuit breaker. As used herein a supply circuit type of “remote disconnecting means or disconnecting means without overcurrent protection” shall refer to a circuit terminating in a device that does not provide a disconnect function such as a power distribution block or fuse, or a circuit that terminates in a disconnect device that does not include overcurrent protection such as a molded case switch.

When the control panel to be analyzed includes a disconnecting means with overcurrent protection one or the following possibilities for the disconnecting means in the supply circuit may be utilized: a fused pullout device such as a UL 1429 Pullout Switch with Branch Circuit Fuses such as UL 248 Fuses; a Fused Switch such as UL 98 Misc. Switches with Branch Circuit Fuses such as UL 248 Fuses; a circuit breaker such as a UL 489 Circuit Breaker; a Combination Starter-Fusible such as a UL 508-Combination Motor Controller; a Combination Starter such as a UL 508 Combination Motor Controller—with Circuit Breaker; a Combination Starter such as UL 508-Combination Motor Controller with MCP; or a Combination Starter such as a UL 508-Combination Motor Controller with Self Protected Starter.

When the control panel to be analyzed includes a remote disconnecting means one or the following possible devices may be utilized for the remote disconnecting means in the supply circuit: Branch Circuit Fuses such as UL 248 Fuses; a Circuit Breaker such as a UL 489 Circuit Breaker; or other types of fuses or circuit breakers.

When the control panel 100 includes remote disconnecting means one or the following possible other devices may be utilized with the remote disconnecting means in the supply circuit: Branch Circuit Fuses such as UL 248 Fuses in a Fuse holder such as a UL 512 Fuse holder; a Bus Bar System, a GFCI Receptacle (UL 943); a Magnetic Controller, including definite purpose, lighting, or HP rated contactor; a Magnetic Motor Starter—Contactor with Overload Relay such as a UL 508 Magnetic Controller; a Manual Motor Starter—MMP such as a UL 508 Manual Motor Controller; a Molded Case Switch such as a UL 489 Molded Case Switch; a Non-Fused Switch such as a UL 508 Manual Motor Controller; a Non-Fused Switch such as a UL 98 Misc. Switch; an Overload relay (UL 508); Power Conversion Equipment—Drive or Soft-Start (UL 508C); a Receptacle (UL 498); Semiconductor Fuses such as UL 248 Fuses in a Fuse holder such as a UL 512 Fuse holder; Semiconductor Fuses in Power Conversion Equipment—Drive or Soft-Start; a Silicon Control Rectifier (UL508C); a Terminal Block—Power Distribution Block (Recognized to UL 1059) with Feeder Circuit Spacing; a Terminal Block (Recognized to UL 1059) with Branch Circuit Spacing; and a Terminal Block-Power Distribution Block (Listed to UL 1953).

Possible overcurrent protective devices for feeder circuits may include Branch Circuit Fuses such as UL 248 Fuses in a Fuse holder such as a UL 512 Fuse holder; Circuit Breakers such as UL 489 Circuit Breakers; Fused Pullouts such as UL 1429 Pullout Switches with Branch Circuit Fuses such as UL 248 Fuses; and Fused Switches such as UL 98 Misc. Switches with Branch Circuit Fuses such as UL 248 Fuses.

Possible other devices that may be used in the feeder circuits of the panel include Bus Bar Systems; Magnetic Controllers including includes definite purpose, lighting, or HP rated contactors; molded Case Switches such as UL 489 Molded Case Switches; Non-Fused Switches such as UL 508 Manual Motor Controllers; Non-Fused Switches such as UL 98 Misc. Switches; Terminal Block-Power Distribution Blocks (Listed to UL 1953); Semiconductor Fuses (UL 248 Fuses) in Fuse holder (UL 512 Fuse holder); Silicon Control Rectifiers (UL508C); Terminal Blocks—Power Dist. Blocks (Recognized to UL 1059) with Feeder Circuit Spacing; Transformers (UL 506 or UL 1561); and Multi-Lug Terminals.

Possible overcurrent protective devices for sub-feeder circuits include Branch Circuit Fuses such as UL 248 Fuses in a Fuse holder such as a UL 512 Fuse holder; Circuit Breakers such as UL 489 Circuit Breakers; Fused Pullouts such as UL 1429 Pullout Switches with Branch Circuit Fuses such as UL 248 Fuses; and Fused Switches such as UL 98 Misc. Switches with Branch Circuit Fuses such as UL 248 Fuses.

Possible other devices for feeder circuits include Bus Bar Systems; Magnetic Controllers including includes definite purpose, lighting, or HP rated contactors; molded Case Switches such as UL 489 Molded Case Switches; Non-Fused Switches such as UL 508 Manual Motor Controllers; Non-Fused Switches such as UL 98 Misc. Switches; Terminal Block-Power Distribution Blocks (Listed to UL 1953); Semiconductor Fuses (UL 248 Fuses) in Fuse holder (UL 512 Fuse holder); Silicon Control Rectifiers (UL508C); Terminal Blocks—Power Dist. Blocks (Recognized to UL 1059) with Feeder Circuit Spacing; Transformers (UL 506 or UL 1561); and Multi-Lug Terminals.

It is understood that the devices mentioned above for the various circuits in the panel 100 are exemplary only, and that greater or fewer numbers of devices, including but not limited to the devices not listed above, may be utilized without limitation to configure the electrical panel 100.

Considering that a large number and variety of circuit devices exist that may be utilized as overcurrent protection devices and other devices in the various circuits of the panel 100, it should be apparent that the possible combinations of numbers of circuits and the number and type of components connected in the circuits in the panel 100 is substantial. That is, the panel 100 is highly configurable to meet the preferences and needs of particular customers. The options in such a highly configurable product can be practically unlimited to provide different and highly customized panels 100 to different purchasers.

Aside from the large number and variety of circuit devices that may be used in any given electrical panel, the components of the panels may themselves be configurable into many possible, and different, configurations. For example, exemplary configurable panelboards are disclosed in commonly owned U.S. patent application Ser. Nos. 12/691,344 filed Jan. 21, 2010 and 11/941,212 filed Nov. 16, 2007, the disclosures of which are incorporated by reference herein. Such a panelboard may be configured with different numbers and arrangements of bus bars to provide a desired number of branch and feeder circuits, may be configured to receive different modular circuit protection devices having different ratings, may be provided (or not) with different barrier elements and covers to isolate terminals of a main service disconnect, may be provided with various enclosure options, and may be provided with spare fuse holders and spare fuses of different ratings corresponding to those used in the panel. The entire panelboard may further be configured to achieve a variety of different voltage, current and interrupting ratings per volume. Still other options are possible.

Because of the high degree of configurability of the panels to provide more or less customized panels to specific users, pricing such electrical panels has conventionally been a tedious, error prone and inefficient process involving multiple parties. First, the purchaser or requester typically contacts a sales representative for the electrical panel provider or supplier, or perhaps a distributor working with the electrical panel provider. In some cases the purchaser or requester will provide detailed information for a proposed panel design. In other cases, the sales representative typically spends a substantial amount of time working with the purchaser or requester to detail the panel requirements and develop a proposed design to meet the needs of the purchaser or requester. The sales representative then compiles the pertinent information for the panel and the information is typically sent to other representatives of the supplier for technical review and approval. If the panel is deemed to be satisfactory, a detailed price quote is generated and provided for final review by the purchaser or requester. This process can take days or weeks from start to finish, assuming that no problems are encountered.

If problems are encountered with the panel information provided, which can occur in various ways as discussed below, the process can take considerably longer. If a problem is discovered with the panel information provided, the information provided by the sales representative is typically marked-up and returned to the sales representative, who then spends more time with the requester or purchaser to resolve any issues. The markup and review process tends to be informal any may occur more than once with any particular request. The mark-up process tends to be rather inefficient and time intensive.

Problems with the information provided for a given panel design can occur in various ways. For example, in conventional practices, the sales representatives have manually filled out paper forms identifying specific components in the panel. Especially when the panel information is hand written or marked-up by hand as the information is reviewed, legibility issues can slow down the process or lead to unnecessary confusion. Multiple persons may participate with hand written notes or hand written mark-ups. Notations may differ from person to person, raising interpretation issues amongst the different parties involved as they review the notes.

Of course, human error in recording the proper information is always possible. Transcribed numbers (e.g., a component model number with numbers reversed), incomplete information (e.g., a component model number that is truncated), or missing information (i.e., a necessary component that is nowhere included in the information) is not always a simple matter to detect.

In some cases the price quote returned for an approved panel may be unacceptably high, and the process must be started over again. However, it may not be immediately apparent to the purchaser or requester, or even to the sales representative, how to effectively achieve the necessary cost savings. Because of the inter-connectivity of the components in an engineered electrical panel, changes in any given component may affect upstream and downstream components in the panel or connected to the panels, and hence cost savings may not necessarily be achieved simply by substituting lower cost components for higher ones. This is particularly so for some types of circuit protection components. Thus, the panel information compilation and submission, technical review of the panel information, and pricing process may be repeated numerous times in a trial and error fashion until an acceptable design is realized both in terms of cost and performance.

Errors in identifying or pricing the components may likewise occur on both ends of the process. That is, properly provided information for the panel may result in an inaccurate panel price, or mistaken panel information may lead to an accurate cost estimate but not for the panel that purchaser actually wanted. Both types of errors are relatively easy to make. Alpha-numeric model numbers and codes for a large number of circuit components can be rather easily confused or mistaken when filling out the necessary forms, and tables of information may need to be consulted that are cumbersome to use. As such, one or more components may be misidentified and/or may be mistakenly priced at an incorrect amount. Regardless of how or where such mistakes originate, associated discrepancies, misunderstandings, and unwelcome surprises may occur that are undesirable to all parties involved.

As new circuit components and products are introduced to the market, older circuit components are phased out, and price and performance data changes over time, obtaining and ensuring up-to-date data for a large number of eligible circuit components that may be used in electrical control panels presents still other challenges. It is possible, for example, for a component to be selected that is no longer available, not yet available, or simply inadvisable for use in the panel from a technical, engineering perspective. Such situations may not be apparent at the time the panel order is received and are not easily detected until some time later, and some rework and delay in clarifying the proper panel configuration and correctly pricing it would typically result, with some inconvenience to all parties involved.

Yet another issue is that an order for an electrical panel might be properly priced at a given point in time, but the panel is not actually ordered or to be supplied until some time later. Thus, components available at the time of pricing may be unavailable at the time that the order is fulfilled, or the pricing of the components may have materially changed in the intervening period.

All of the above considerations are complicated when multiple panels are ordered and priced at the same time for a given project. For example, dozens of electrical panels may be necessary for some electrical power systems, and multiple panels may be affected with one or more of the problems mentioned above. As such, the trial and error processes in reviewing and accurately pricing them, and associated inefficiencies, may propagate and lead to much confusion, delay, and unreliability in providing cost quotes and pricing information.

More recently, software spreadsheets have been utilized to process orders for configurable electrical panels. Software programs such as Microsoft Excel® can facilitate a much more rapid processing, transfer, and documentation of large amounts of data for an electrical panel and its components, but many of the difficulties mentioned above remain. Mistyped information remains a problem, and so does out-of-date data contained in the spreadsheets. It is still possible to include components that may not properly be used together for technical, engineering reasons. The spreadsheets are also typically uncontrolled and subject to inadvertent change. Especially when the spreadsheets are electronically marked up and emailed back and forth among the various parties involved, file integrity issues and confusion among various versions of the spreadsheets may ensue.

Also, no central database to store proposed and quoted projects is typically utilized that would be beneficial to purchasers or requesters as well as to panel providers or suppliers. Thus, instead of iteratively modifying previous panel information for review and pricing purposes, the process must generally start anew.

Incentives and discounts made available to certain purchasers may further complicate the review and pricing process and lead to potential error and rework that contributes to delays in providing reliable cost estimates.

Database systems exist that enable price estimates to be rather quickly and reliably generated. Such databases, however, are typically only accessible to a limited number of persons associated with panel suppliers, and its effective use is dependent on the quality of information supplied to it. Component information for configurable products typically are separately entered or input to such systems. Hence, many of the issues described above still apply. Even if electronic information is provided in a spreadsheet or other form for pricing purposes, data formatting and compatibility issues can frustrate their effective use.

### II. The System of the Invention

Inventive computer-implemented systems, methods and user interfaces are disclosed facilitating accurate configuration of customizable products, such as electrical control panels, to meet user defined specifications, together with the ability to instantaneously and efficiently quote a price of the customized design to a customer. Inefficient and lengthy approval and valuation process for such designs are substantially avoided to the benefit of panel suppliers and purchasers alike. The advantages of the system, methods, and user interfaces include at least the following benefits.

Manual typing of data is not required because the system utilizes interactive screen displays including pre-defined drop-down menus and lists of configurable product selections, with each of the selections presented in the menus and lists corresponding to detailed information contained in system databases. Human error in entering large amounts of data is avoided, and integrity of the data necessary to system operation ensured.

System users may design and virtually build their own configurable products using interactive screen displays. and instantaneously receive price quotes and availability lead-times for their custom designed product without the assistance of a sales representative, and without delay. Human error in configuring the panels and pricing the panels is minimized, if not avoided altogether. Engineering logic rules may be applied by the system to any risk of configurable designs being created that are not electrically feasible or advisable by preventing a user from selecting problematic combinations of components.

Configured products virtually designed and built by the user on the system may be saved on archived on the system, providing a searchable list of past and present projects in system databases for later retrieval and review. System users can therefore access, view and/or or modify previous configurable product projects saved on the system, and re-price them on demand to obtain a new price quote.

Approval drawings, bill of material documents, and pricing documents can be created from the system in a uniform manner across a large number of system users associated with panel suppliers, purchasers, or third parties.

Still other benefits are provided and are discussed in detail below. Method aspects are in part apparent and in part specifically discussed in the following description.

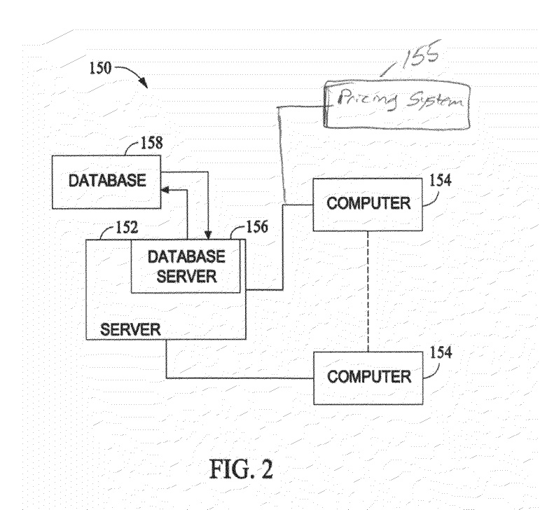

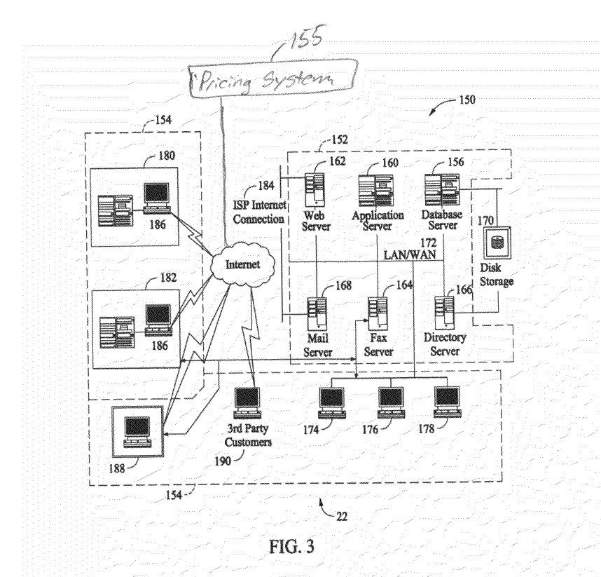

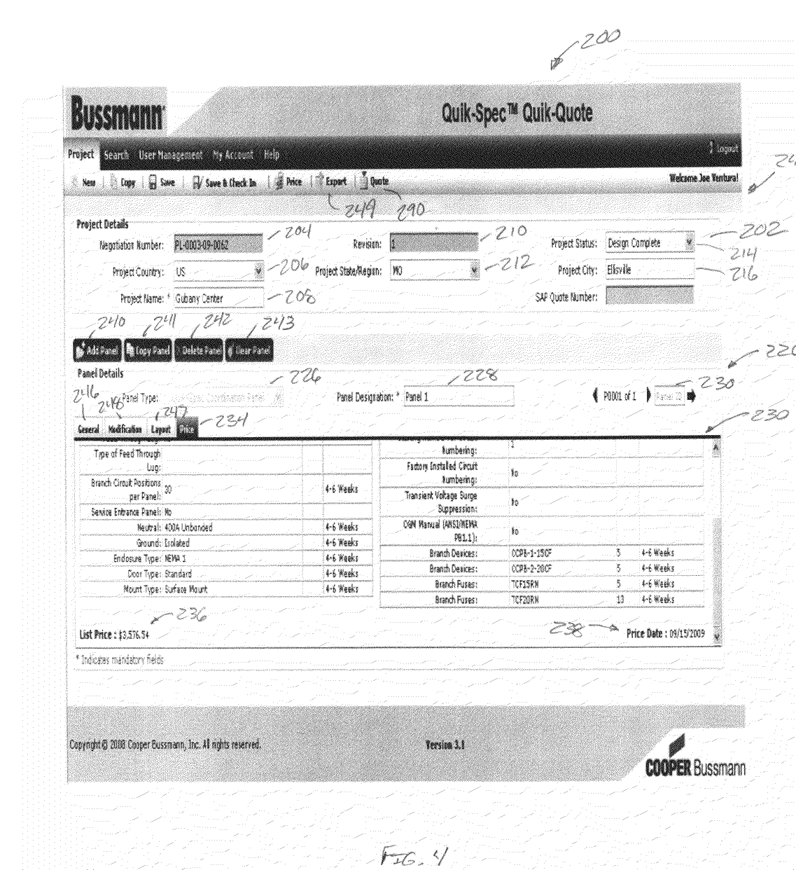

FIGS. 2 and 3 illustrate aspects of an exemplary configurable product cost estimate system 150 for complex, configurable products such as electrical control panels. FIGS. 4-7 illustrate an exemplary user interface and exemplary screen displays therefor. Processes associated with the system 150 and user interface are partly described and partly apparent from the figures and description herein.

In one embodiment the system 150 is a computer program or software embodied on a computer readable medium and utilizing, for example, a Structured Query Language (SQL) with a client user interface front-end and a web interface for user input, access, and information retrieval and reports by persons interested in assessing and evaluating cost information for a proposed electrical panel design.

The cost estimate system 150 may be web enabled and may be run on a business-entity intranet or alternatively may be fully accessed by individuals having an authorized access outside the firewall of the business-entity through the Internet. In an exemplary embodiment, the cost estimate system 150 may be run in a Windows® NT environment or operating system that is commercially available from Microsoft Corporation of Redmond, Wash. The application may be flexible and designed to run in various different environments without compromising any major functionality.

FIG. 2 is a simplified block diagram of an exemplary embodiment of the cost estimate system 150 including a server system 152, and a plurality of client sub-systems, also referred to as client systems 154, connected to the server system 152. Computerized modeling and grouping tools, as described below in more detail, are stored in the server system 152 and can be accessed by a requester at any one of the client systems 154. In one embodiment, the client systems 154 are computers or other electronic devices including a web browser, such that the server system 152 is accessible to the client systems 154 using, for example, the Internet.

The client systems 154 may be interconnected to the Internet through many interfaces including, for example, a network such as a local area network (LAN) or a wide area network (WAN), dial-in-connections, cable modems and special high-speed ISDN lines. The client systems 154 may be any device capable of interconnecting to the Internet including a web-based phone, personal digital assistant (PDA), or other web-based connectable equipment or equivalents thereof. A database server 156 is connected to a database 158 containing information on a variety of matters, as described below in greater detail. In one embodiment, the database 158 is centralized and stored on the server system 152, and the database 158 be accessed by potential users at one of the client systems 154 by logging onto the server system 152 through one of the client systems 154. In an alternative embodiment, the database 158 may be stored remotely from server system 152 and may be non-centralized. The client systems 154 provide front end interfaces for interested users to select and provide information needed to price a configurable product, such as the electrical panel 100.

A back-end pricing system 155 is further provided that may also be a web enabled, server based distributed computer system including a database server and database including price data and information for the eligible circuit components that may be utilized to configure an electrical panel, for example. Thus, once the requisite panel information is supplied via the front end client systems 154, the system 150 may use that information to retrieve price information from the pricing system 155. In one exemplary embodiment, the pricing system may include SAP enterprise resource planning software including a pricing module, although this is by no means required in other embodiments. Once obtained, the price information may be communicated to interested parties via the front end client systems 154. Communication between the front end client systems 154 and the back end pricing system 155 is generally transparent to the system users at the front end client systems 154.

FIG. 3 is an expanded block diagram of an exemplary embodiment of a server architecture of the cost estimate system 150 including the server system 152 and the client systems 154. The server system 152 may include the database server 156, an application server 160, a web server 162, a fax server 164, a directory server 166, and a mail server 168. A disk storage unit 170 may be coupled to the database server 156 and the directory server 166. The servers 156, 160, 162, 164, 166, and 168 may be coupled in a local area network (LAN) 172. In addition, a system administrator's workstation 174, a user workstation 176, and a supervisor's workstation 178 may be coupled to the LAN 172. Alternatively, workstations 174, 176, and 178 may be coupled to LAN 172 using an Internet link or are connected through an Intranet.

Each workstation 174, 176, and 178 may be a personal computer or other electronic device having a web browser. Although the functions performed at the workstations typically are illustrated as being performed at respective workstations 174, 176, and 178, such functions may be performed at one of many personal computers coupled to the LAN 172. Workstations 174, 176, and 178 are illustrated as being associated with separate functions only to facilitate an understanding of the different types of functions that can be performed by individuals having access to the LAN 172.

The server system 152 in one embodiment is configured or adapted to be communicatively coupled to various individuals via some of the client systems 154, including employees 180 associated with the cost estimate system 150, and to third parties 182 in communication with the server system 152 using, for example, an ISP Internet connection 184. The communication in the exemplary embodiment is illustrated as being performed using the Internet, however, any other wide area network (WAN) type communication can be utilized in other embodiments. That is, the cost estimate system 150, and its operating algorithms and processes described below are not limited to being practiced using the Internet.

In an exemplary embodiment, any authorized individual having a workstation 186, 188 can access the server system 152 via one of the client systems 154. At least one of the client systems 154 includes a manager workstation 188 located at a remote location. Workstations 186 and 188 may be personal computers or other electronic devices having a web browser. Additionally, third party customers may communicate with the server system 152 via a workstation 190 having, for example, a web browser.

The fax server 164 may communicate with remotely located client systems 154, including the workstations 186, 188 and 190. The fax server 164 may be configured or adapted to communicate with other client systems including but not limited to the workstations 174, 176 and 178 as well for reporting purposes.

The technical effect of the processes and systems described herein is achieved when data and information pertaining to configurable product design, and components and devices utilized in the configurable product design is entered, transmitted, downloaded or otherwise accepted by the cost estimate system 150. The data and information used by the cost estimate system 150 may be supplied an accepted through any of the workstations connected to the server system 152 as described above, or may be supplied from other sources if desired. Exemplary data and information utilized by the system 150 is described in some detail below.

The data and information supplied to the system 150 may be stored or archived in the aforementioned server system 152, and the data and information may be accessed by the system 150 to permit a reliable cost assessment, evaluation or analysis of a configurable product design in a dramatically reduced amount of time and with reduced labor, while substantially avoiding and eliminating human error.

The cost estimate system 150 in one embodiment is a comprehensive web application tool for providing more or less real time cost estimate information for complex configurable products such as electrical control panels. The cost estimate system 150 in one implementation is a database driven tool, where current and up-to-date device details for the control panel design are available and accessible in a database and the user selects the devices to be included in a panel configuration from drop-down lists and menus. The system 150 may include large databases storing product details of major electrical components available to electrical control panel designers, sometimes referred to as eligible devices. By providing an up-to-date and accurate database of eligible device details, the user need not separately compile the necessary information to quickly and accurately price a configurable product design. The system databases may be periodically updated to purge obsolete data and information, make and necessary revisions to the data, include new products and information, or to reflect changes to the standards of interest and information needed to evaluate them. Data and information to be stored in the databases may be directly supplied by device manufacturers, or gathered by responsible third parties.

Component selection and input processes for the system 150 may be similar to that described in commonly owned U.S. Pat. No. 7,779,371 (incorporated by reference herein) wherein pre-defined circuit components are made available to users to select via the screen displays in a step-by-step fashion wherein the user is guided through the component selection process circuit-by-circuit in each panel with a good deal of flexibility to add panels, circuits, and components in a virtual design environment. Optionally, as also disclosed in U.S. Pat. No. 7,779,371 the system 150 may accommodate user-defined custom circuit components that are not included in the system databases. Panel projects may be saved and archived in the system databases with unique identifiers allowing the data associated with completed projects and projects in process so that the information can be retrieved, compared, re-used and modified in a beneficial manner without starting over from scratch.

Through the use of drop-down lists and menus in a series of interactive screen displays, the system user may provide component selection inputs for the various circuits in an electrical control panel with a significantly reduced chance of error. In various possibilities contemplated, the system user may be a sales representative for an electrical panel supplier or distributor, a purchaser directly accessing the system, or a third party authorized to access the system. Because the circuit component names and model numbers are provided to the user for selection, as opposed to the user providing the names and model numbers and other data, instances of mistakenly provided component data are entirely avoided. That is, human error in reversing portions of alphanumeric products codes or providing incomplete information for a given circuit component is avoided entirely because the system user need not enter the alphanumeric product codes and other data at all, and once a component is selected, all of its necessary data and information already exists on the system and need not be of concern to the system user.

Additionally, engineering logic is built-in to the system such that a user is prevented from selecting an impermissible combination of components in a configurable electrical panel. As such, incompatibility issues and selections that would violate predetermined technical engineering panel design standards, are prevented from being selected in a configurable panel design, or prevented from otherwise being accepted for pricing. Alternatively, engineering logic is provided to preliminarily review accepted panel information and flag problems to the system user more or less immediately. Such technical problems as component incompatibility issues and selections that would violate predetermined technical engineering panel design standards could then be identified and resolved very early in the configurable panel component selection process.

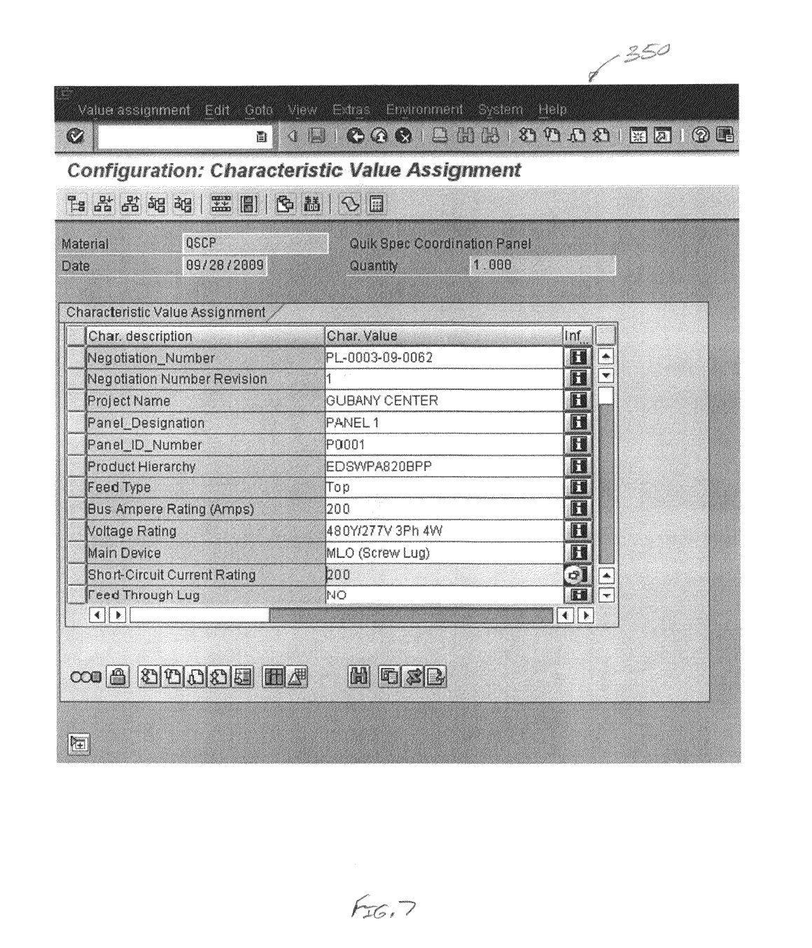

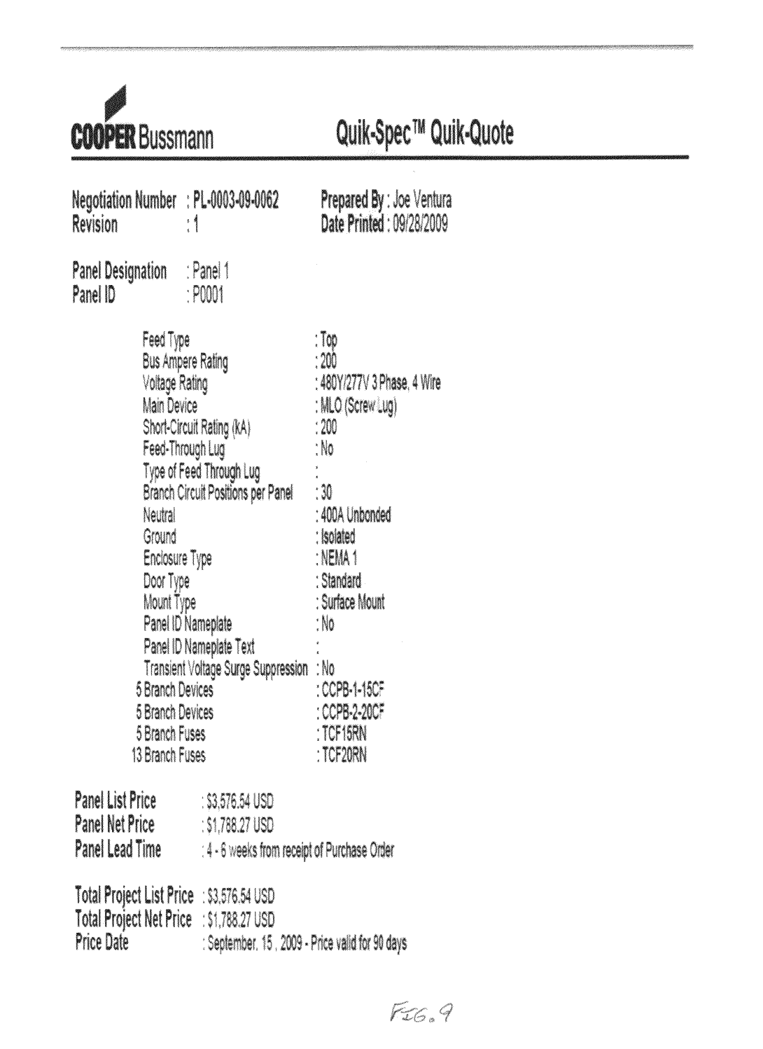

Once the panel selection inputs are completed, the system 150 can provide a number of detailed reports and information concerning different aspects of the panel as demonstrated in FIGS. 4-9. Bills of materials and pricing or cost quotes (FIG. 9) can be created, detailed characteristics of the panel can be reviewed (FIG. 7), and even component details can be retrieved and displayed for further study.

FIG. 4, for example, illustrates an exemplary user interface displaying a project screen 200 for a user of the system after the panel has been configured with the virtual design environment. As shown in the example of FIG. 4, the project screen 200 includes a project detail section 202 including various information fields populated by the system 150 that correspond to a particular panel design which has been configured with the system. In the example shown, the project detail section 202 includes a project identification number field 204, a project country field 206, a project name field 208, a revision number field 210, a project state/region field 212, a project status field 214, a project city field 216, and an SAP quote number field 218. In general, any of these fields may also be searched to retrieve a particular project for the benefit of an authorized system user having appropriate access to projects stored on the system 150. Appropriate security features may be integrated to prevent unauthorized access of project information, as well as to prevent authorized users from accessing projects created by other authorized users without permission.

A panel detail section 220 is also provided in the exemplary project screen 200 shown in FIG. 4. The panel detail section includes a panel type field 226, a panel designation field 228, and a panel ID field 230. A viewing area 230 is provided allowing the user to review detailed panel information including the type, number and specific identifications of the components in the panel, as well as other information of interest concerning the panel enclosure, the panel door, mounting details, ratings for the panel, and other information. As shown in the exemplary viewing area 230, availability information is also included for the panel delivery. User selectable tabs allow a user to review the information in a general level, a modification level, a layout level, and a price level.

Because in the exemplary screen 200 shown in FIG. 4 the price tab 234 has been selected, price information is included in the detailed viewing area 230 for the user's inspection. As shown, the list price 236 of the panel displayed is shown, along with the date 238 that the panel was priced. As shown just above the panel detail section 220, user selectable tabs 240, 241, 242, 243 are provided to respectively allow the user to add a panel to the project, copy a panel, delete a panel, or clear the panel from the system. In the upper toolbar in the screen, the data shown in FIG. 4, including the price may be saved.

Additional information for the panel may be retrieved by the user with tabs 246 (general) and 247 (layout), and the panel may be modified by selecting tab 248 and using the drop down menus to change components, remove components, or introduce new ones.

By virtue of the communication between the front end virtual design environment and back end pricing environment of the system 150, nearly instantaneous price information is made available to the user. In the case of a back end SAP system being utilized to generate the price information, one material number is created in SAP and linked to each panel created on the system 150. This is specifically contrasted with conventional practices wherein one material number is defined on a virtual design/build system and another and different number is defined in an SAP system. Still further, the component selection and information accepted by the front end portions of the system are directly used to communicate with the back end system for pricing information retrieval and analysis, as contrasted with conventional practices wherein the information would be separately entered to an SAP system for pricing purposes. The front and back end portions in the system 150 automatically communicating with one another eliminates much time and effort in comparison to previous practices.

Additionally, the user may modify the panel and layouts and re-price the modified panel and layouts in more or less real time to see how changes in the panel designs affect cost. The data and details thereof for any panel analyzed can also be exported from the system 150 to another system using, for example, Microsoft Excel, or another application. As one can see in FIG. 4, an export button 249 is provided in the toolbar 249 below the main toolbar at the upper portion of the screen.

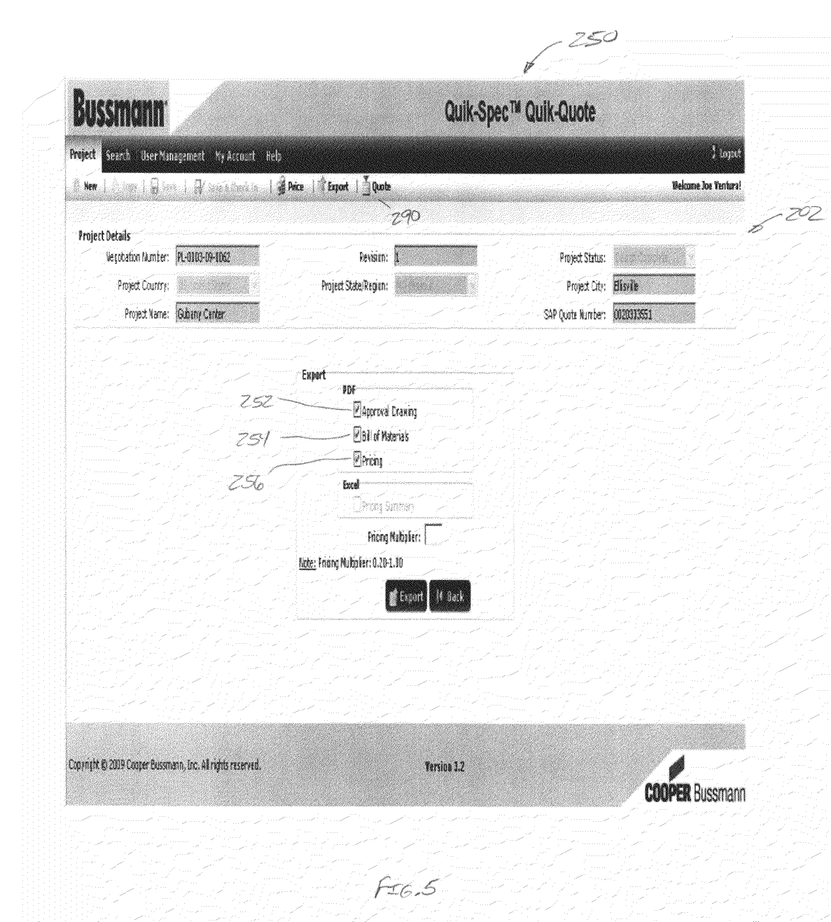

FIG. 5 is an example of a user interface displaying a project export screen 250 for a user of the system. The project detail section 202 is repeated in the export screen 250, and as seen in FIG. 5, the user may choose to export a panel drawing, a bill of materials, and/or pricing information for the panel analyzed with checkboxes 252, 254, 256. Thus, project information can be exported from the system 150 and used with other systems of for purposes apart from the system 150 for the convenience of system users.

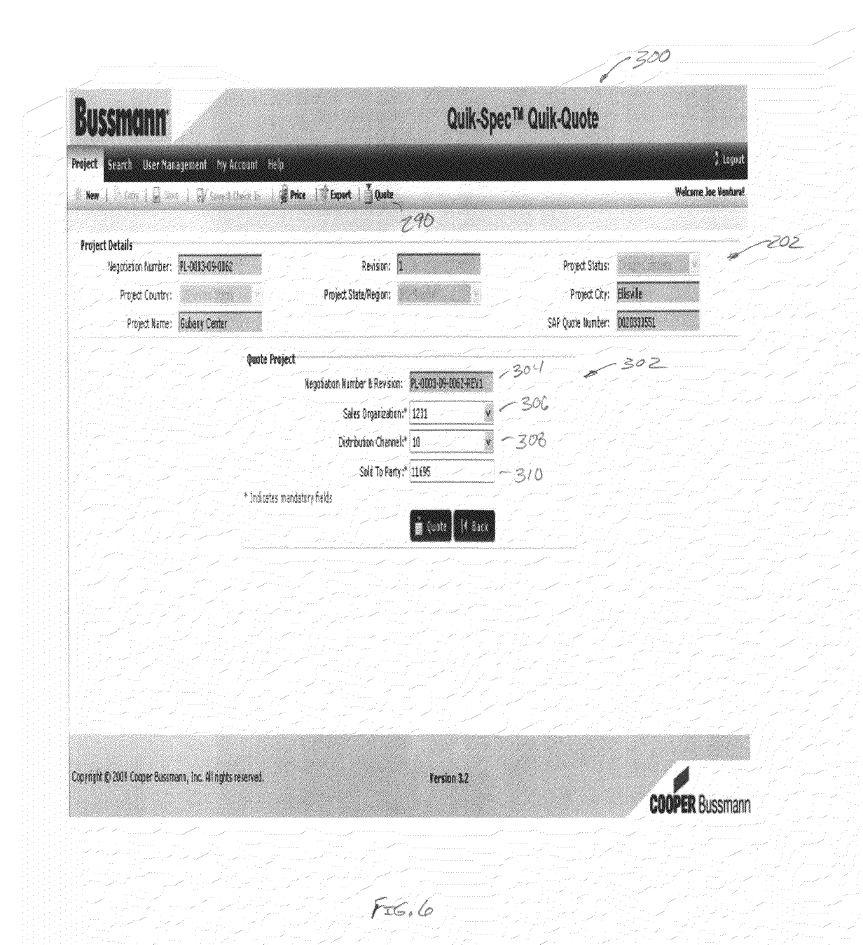

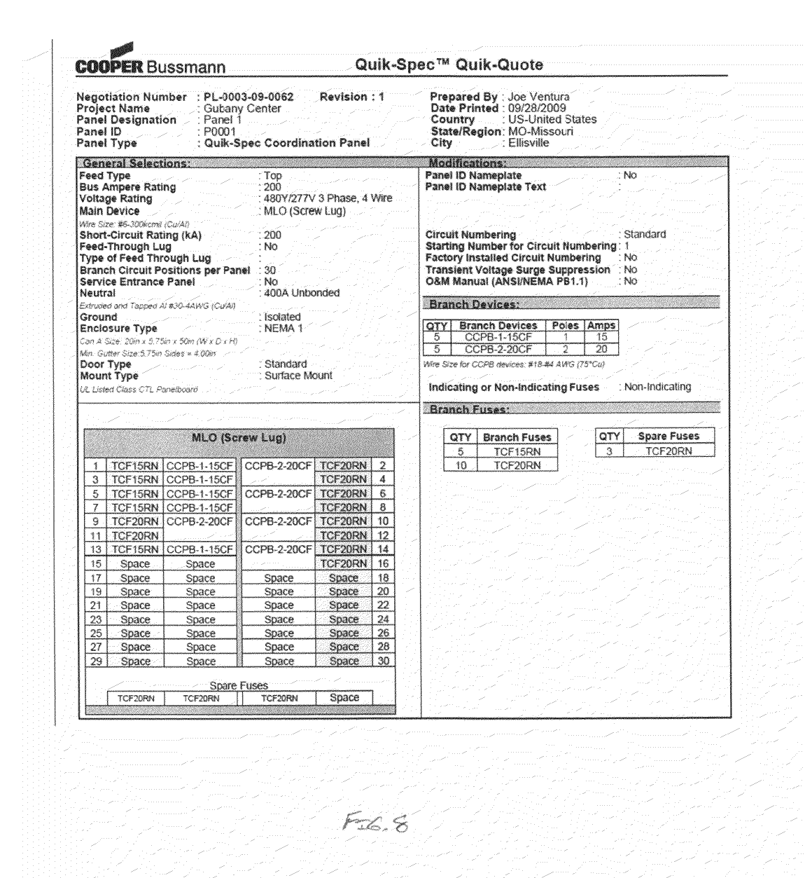

FIG. 6 is an example of a project cost quote screen 300 for a user of the system presented in response to the quote button 290 being selected by a user in FIG. 4. The project detail section 202 is again repeated on this screen, together with a quote project area 302 including fields such as a identification number & revision field 304, a sales organization field 306, a distribution channel field 308, and a sold to party field 310 so that the quote can be linked to one or more of these fields and later retrieved. When the user proceeds to request the quote by selecting the quote button 190, the system 150 proceeds to generate pricing information, and does so quickly and reliably. FIGS. 8 and 9 show an approval drawing and a price sheet that may be included in a quote. It is understood that varying levels of detail may be provided with similar effect.

FIG. 7 shows an exemplary configuration screen 350 including still other exemplary information that is stored in the system 150 for electrical panels. As can be seen from FIG. 7, the system 150 compiles and stores a host of information for panels other than price, such as the technical details shown relating to performance characteristics for selected components. Such information can be beneficial to analyzing the panel from a technical perspective apart from costs and can be exported to other systems if desired. Thus, the design and build capabilities are comprehensive, and a user can review a panel design at various levels of detail to ensure the user-defined specifications for panel will be met.

FIG. 8 is an exemplary approval drawing generated by the system for an exemplary electrical panel. FIG. 9 is an exemplary bill of material and pricing quote generated by the system for the exemplary electrical panel. Still other reports can be provided and generated by the system 150 in varying levels of detail. As shown in FIG. 9, different types of cost information may be included, such as a list price and net price reflecting any discounts or incentives that may apply. Such discounts and incentives may be automatically administered by the system 150 with minimal chance of error.

The user interface displays and screens such as those described capably present voluminous amounts of data and circuit device details in easy to use, menu-driven form with intuitive links and graphical displays to quickly understand the circuit and device selections, the current point of analysis at each step, and step-by-step analysis results and feedback, including price information to comprehensively evaluate a virtually designed/built configurable product on the system 150.

The user interface displays may be implemented conventionally in a computer program embodied on a computer readable medium and having segments of code or instructions executed by a computer that correspond to the various functions and features described above.

It is understood that additional segments of code corresponding to additional displays, links, graphics, information, and indicia may be provided in further embodiments, and further that not all of the exemplary information provided in the above-described displays and screens need be used in some embodiments of the invention. The user interface displays may be varied to suit the needs of specific electrical systems, may be customized for particular devices, and may be used for assessment and evaluation of configurable products other than electrical control panels with appropriate renaming of the pertinent fields.

When the user interface displays are implemented on a network-based computer system as described above, the system may flexibly present information and perform analysis of proposed designs to multiple users simultaneously, and through menu-driven graphical displays and information links, system users may quickly access needed information to properly manage and reliably evaluate complex configuration of electrical panels. Device selections, data, and analysis may be saved on the system 150 by virtue of the unique project names and panel designations for later access by authorized users. As such, the user need not complete the entire analysis in a single session, but rather may conveniently exit the system and later return to the project. Detailed reports may likewise be saved on the system 150 for further study and analysis.

While network-based computer systems are described, it is understood that much or all of the functionality disclosed could likewise be implemented on a personal computer, laptop or notebook computer, or other processor based devices having the necessary information stored therein. Varying degrees of sophistication and complexity may be provided to meet the preferences of various end users of the system.

### III. Exemplary Methods and Processes of the Invention

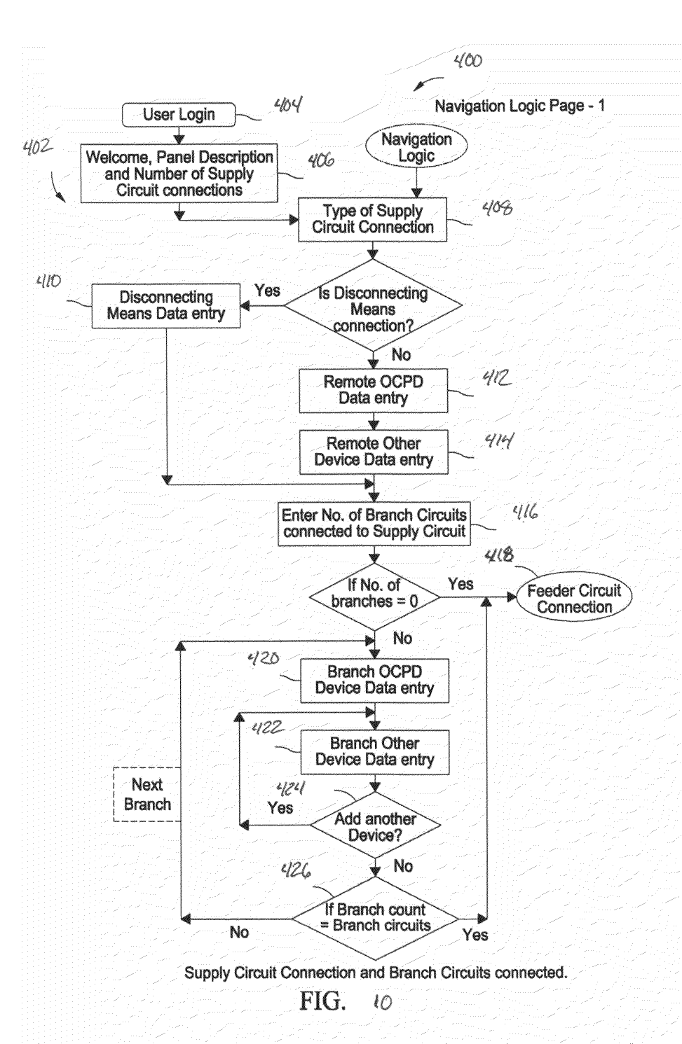

FIGS. 10-12 illustrate portions of a flowchart concerning exemplary data entry processes 400 utilized by the configurable product cost estimate system 150 described above. The data entry process 400 in one embodiment facilitates user identification and entry of components and devices in a proposed electrical panel design as configured to user defined specifications, such as the panel 100 shown in FIG. 1.

FIG. 10 illustrates a supply circuit connection data entry processing algorithm portion 402 of the data entry process 400. As shown in FIG. 10, the algorithm portion 402 includes prompting 404 a user to logon to the system 150, and presenting 406 a welcome to the user that facilitates user identification of or description of the electrical control panel to be analyzed, as well as prompting user entry of a number of supply circuits utilized for the proposed electrical control panel as configured by the user.

After the welcome 406 is completed, the system prompts a user to enter or input 408 the type of supply circuit connection to be used with the proposed control panel as configured. For example, two types of supply circuits are predominately used in supply circuits, namely a supply circuit having disconnecting means with overcurrent protection, or a remote disconnecting means or disconnecting means without overcurrent protection. As used herein, a supply circuit type of “disconnecting means without overcurrent protection” shall refer to a circuit terminating in a device that provides both a disconnecting means and an overcurrent protection device, such as a fused disconnect switch or circuit breaker. As used herein a supply circuit type of “remote disconnecting means or disconnecting means without overcurrent protection” shall refer to a circuit terminating in a device that does not provide a disconnect function such as a power distribution block or fuse, or a circuit that terminates in a disconnect device that does not include overcurrent protection such as a molded case switch.

Depending on whether the user input or selection at step 408 is a disconnecting means with overcurrent protection or a remote disconnecting means, the system proceeds to prompt data input, selection or entry in steps 410, 412, and 414 for the applicable devices in the control panel to be utilized.

In an exemplary embodiment, when the control panel being configured includes a disconnecting means with overcurrent protection selected at step 410 the system may require selection of one or the following possibilities for the disconnecting means in the supply circuit: a fused pullout device such as a UL 1429 Pullout Switch with Branch Circuit Fuses such as UL 448 Fuses; a Fused Switch such as UL 98 Misc. Switches with Branch Circuit Fuses such as UL 448 Fuses; a circuit breaker such as a UL 489 Circuit Breaker; a Combination Starter-Fusible such as a UL 508-Combination Motor Controller; a Combination Starter such as a UL 508 Combination Motor Controller—with Circuit Breaker; a Combination Starter such as UL 508-Combination Motor Controller with MCP; or a Combination Starter such as a UL 508-Combination Motor Controller with Self Protected Starter.

Further, for each of the possible selections for the disconnecting means at step 410, data and information pertaining to the devices may be entered, input or selected by the user, or alternatively the system may retrieve device data and information from the system database once the device is identified by the user. The data and information may include a manufacturer name, device codes supplied by the manufacturer to identify a specific device, and a short description, name, or title of the device. The data may also include current ratings, voltage ratings, short-circuit current ratings, interrupting ratings, let thru current ratings, i²t ratings, and other product information of interest needed to analyze, assess, or evaluate the proposed control panel being configured by the user. In one exemplary embodiment, such data and information for a variety of available devices offered from various manufacturers are input by system operators and stored and archived in the databases 154 (FIG. 2) of the system 150 for use by the system without manual entry by the user, although in some embodiments the data and information could be manually entered by the user if desired.

In an exemplary embodiment, when the control panel being configured includes a remote disconnecting means selected at step 412 the system may require selection of one or the following possible devices for the remote disconnecting means in the supply circuit: Branch Circuit Fuses such as UL 448 Fuses; a Circuit Breaker such as a UL 489 Circuit Breaker; or a Fuse or Circuit Breaker—Not Specified.

Further, for each of the possible selections for the remote disconnecting means at step 412, data and information pertaining to the devices may be entered, input or selected by the user, or alternatively the system may retrieve device data and information from the system database once the device is identified by the user. The data may include a manufacturer name, device codes supplied by the manufacturer to identify a specific device, and a short description, name, or title of the device. The data may also include current ratings, voltage ratings, short-circuit current ratings, interrupting ratings, let thru current ratings, i²t ratings, and other product information of interest needed to analyze, assess, or evaluate the proposed control panel being configured. In one exemplary embodiment, such data and information for a variety of available devices offered from various manufacturers are input by system operators and stored and archived in the databases 154 (FIG. 2) of the system 150 for use by the system without manual entry by the user, although in some embodiments the data and information could be manually entered by the user if desired.

In an exemplary embodiment, when the control panel to be analyzed includes remote disconnecting means selected at step 414 the system may require selection of one or the following possible other devices utilized with the remote disconnecting means in the supply circuit: Branch Circuit Fuses such as UL 448 Fuses in a Fuse holder such as a UL 512 Fuse holder; a Bus Bar System, a GFCI Receptacle (UL 943); a Magnetic Controller, including definite purpose, lighting, or HP rated contactor; a Magnetic Motor Starter—Contactor with Overload Relay such as a UL 508 Magnetic Controller; a Manual Motor Starter—MMP such as a UL 508 Manual Motor Controller; a Molded Case Switch such as a UL 489 Molded Case Switch; a Non-Fused Switch such as a UL 508 Manual Motor Controller; a Non-Fused Switch such as a UL 98 Misc. Switch; an Overload relay (UL 508); Power Conversion Equipment—Drive or Soft-Start (UL 508C); a Receptacle (UL 498); Semiconductor Fuses such as UL 448 Fuses in a Fuse holder such as a UL 512 Fuse holder; Semiconductor Fuses in Power Conversion Equipment—Drive or Soft-Start; a Silicon Control Rectifier (UL508C); a Terminal Block—Power Distribution Block (Recognized to UL 1059) with Feeder Circuit Spacing; a Terminal Block (Recognized to UL 1059) with Branch Circuit Spacing; and a Terminal Block-Power Distribution Block (Listed to UL 1953).

Further, for each of the possible selections for devices selected at step 414, data and information pertaining to the devices may be entered, input or selected by the user, or alternatively the system may retrieve device data and information from the system database once the device is identified by the user. The data may include a manufacturer name, device codes supplied by the manufacturer to identify a specific device, and a short description, name, or title of the device. The data may also include current ratings, voltage ratings, short-circuit current ratings, interruption ratings, let thru current ratings, i²t ratings, and other product information of interest needed to analyze, assess, or evaluate the proposed control panel as it is configured. In one exemplary embodiment, such data and information for a variety of available devices offered from various manufacturers are input by system operators and stored and archived in the databases 154 (FIG. 2) of the system 150 for use by the system without manual entry by the user, although in some embodiments the data and information could be manually entered by the user if desired.

Once the data input or selection steps 410, 412 and 414 are performed for the applicable devices of the proposed control panel as configured, the system prompts 416 the user to enter the number of branch circuits connected to the supply circuit for the proposed panel being configured. The prompt may ask the user to enter the number, or ask the user to select the number of branch circuits from a menu or list. In one embodiment, user input selection values of 0 through 10 are made available for user selection of the number of branch circuits connected to the supply circuits in the proposed panel being configured, although input or selection values greater than 10 may be used if desired.

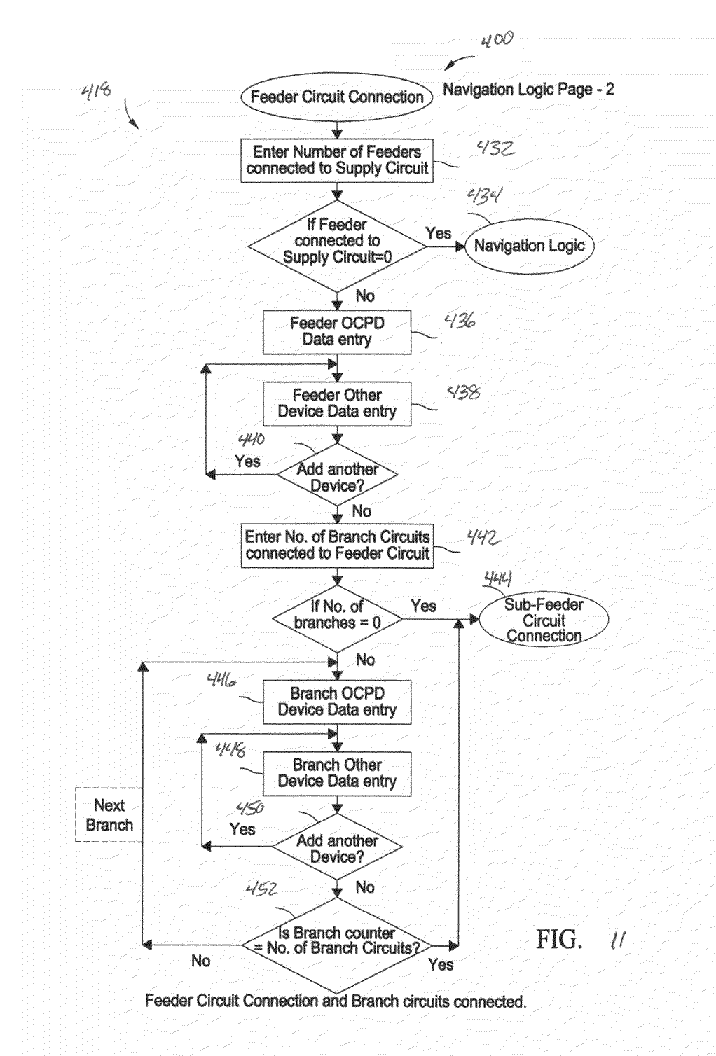

If the user selects or enters 0 for the number of branch circuit connected to supply circuits, the system enters 418 the feeder circuit data entry processing algorithm shown in FIG. 11. If the user selects or enters a non-zero value, the system prompts 420 and 422 the user to input, enter or select an overcurrent protection device for the branch circuit at step 420. At step 422, the system prompts the user to input, enter or select an “other device” for the branch circuit, and also prompts the user to enter whether the branch circuit contains yet another device at step 424. If the user chooses to add another device at step 424, the system returns to step 422. Possible devices to be entered, input or selected for the branch circuits at steps 420, 422 and 424 include any of the devices described above in reference to the steps 410, 412 and 414. It is understood that the devices mentioned in reference to steps 410, 412 and 414 are exemplary only, and that greater or fewer numbers of devices, including devices not listed above, may be may be entered, input or selected in other embodiments of the invention without limitation.

If the user does not choose to add another device at step 424, the system determines 426 whether the branch count obtained from step 416 equals the number of branch circuits entered into the system at steps 420 and 422. If the branch count is less than the number of branch circuits entered by the user, the system returns to step 420 for the next branch to be entered. If the branch count is equal to the number of branch circuits entered by the user, the system enters 418 the feeder circuit data entry processing algorithm shown in FIG. 11.

Turning now to FIG. 11, the feeder circuit data entry processing algorithm portion 418 of the navigational and data entry process 400 is illustrated. The feeder circuit algorithm portion 418 includes prompting 432 the user to enter, input or select the number of feeder circuits connected to the supply circuit. The prompt 432 may ask the user to enter the number of feeder circuits, or ask the user to select the number of feeder circuits from a menu or list. In one embodiment, user input selection values of 0 through 10 are made available for user selection of the number of feeder circuits connected to the supply circuits in the proposed panel being configured, although input or selection values greater than 10 may be used if desired.

If the number of feeder circuits entered, input or selected by the user at step 432 is zero, the systems enters navigation logic 434 as explained below. If the number of feeder circuits entered, input or selected by the user at step 432 is a non-zero value, the system proceeds to prompt the user to input, enter or select an overcurrent protection device for the feeder circuit at step 436. At step 438, the system prompts the user to input, enter or select an “other device” for the feeder circuit, and also prompts the user to enter whether the branch circuit contains yet another device at step 440. If the user chooses to add another device at step 440, the system returns to step 438.

There are two basic types of devices for feeder circuits represented in steps 436 and 438. Possible overcurrent protective devices for feeder circuits to be entered, input or selected by the user at step 436 include Branch Circuit Fuses such as UL 448 Fuses in a Fuse holder such as a UL 512 Fuse holder; Circuit Breakers such as UL 489 Circuit Breakers; Fused Pullouts such as UL 1429 Pullout Switches with Branch Circuit Fuses such as UL 448 Fuses; and Fused Switches such as UL 98 Misc. Switches with Branch Circuit Fuses such as UL 448 Fuses.

Possible other devices for feeder circuits to be entered, input or selected by the user at step 438 include Bus Bar Systems; Magnetic Controllers including includes definite purpose, lighting, or HP rated contactors; molded Case Switches such as UL 489 Molded Case Switches; Non-Fused Switches such as UL 508 Manual Motor Controllers; Non-Fused Switches such as UL 98 Misc. Switches; Terminal Block-Power Distribution Blocks (Listed to UL 1953); Semiconductor Fuses (UL 448 Fuses) in Fuse holder (UL 512 Fuse holder); Silicon Control Rectifiers (UL508C); Terminal Blocks—Power Dist. Blocks (Recognized to UL 1059) with Feeder Circuit Spacing; Transformers (UL 506 or UL 1561); and Multi-Lug Terminals.

It is understood that the devices mentioned in reference to steps 436 and 438 are exemplary only, and that greater or fewer numbers of devices, including devices not listed above, may be entered, input or selected in other embodiments of the invention without limitation.

If the user does not choose to add another device at step 440 for the feeder circuit, the system prompts 442 the user to enter, input or select the number of branch circuits connected to the feeder circuit. The prompt 442 may ask the user to enter the number of branch circuits connected to the feeder circuit, or asks the user to select the number of branch circuits from a menu or list. In one embodiment, user input selection values of 0 through 10 are made available for user selection of the number of branch circuits connected to the feeder circuit in the proposed panel being configured, although input or selection values greater than 10 may be used if desired.

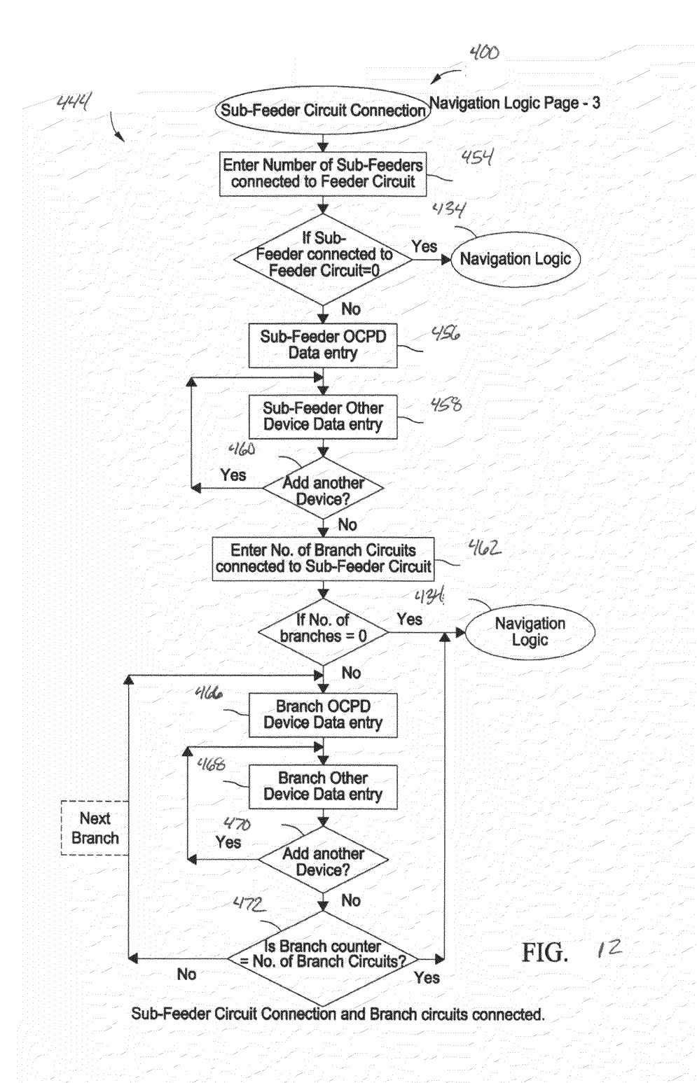

If the number of branch circuits entered, input or selected by the user at step 442 is zero, the systems enters 444 the sub-feeder circuit connection data entry processing algorithm shown in FIG. 12. If the number of branch circuits entered, input or selected by the user at step 442 is a non-zero value, the system proceeds to prompt the user to input, enter or select an overcurrent protection device for the branch circuit at step 446. At step 448, the system prompts the user to input, enter or select an “other device” for the branch circuit, and also prompts the user to enter whether the branch circuit contains yet another device at step 450. If the user chooses to add another device at step 450, the system returns to step 448.

In one embodiment, the possible devices to be entered, input or selected by the user for the branch circuits at steps 446 and 448 may include any of the branch circuit devices described in relation to steps 420 and 422 of FIG. 10. While specific devices are described, it is understood that the devices for the branch circuits are exemplary only, and that other devices may be entered, input or selected by a user in another embodiment.

If the user does not choose to add another device at step 450, the system determines 452 whether the branch count obtained from step 442 equals the number of branch circuits entered into the system at steps 446 and 448. If the branch count is less than the number of branch circuits entered by the user, the system returns to step 446 for the next branch to be entered. If the branch count is equal to the number of branch circuits entered by the user, the system enters 444 the sub-feeder circuit data entry processing algorithm 444 shown in FIG. 12.

FIG. 12 illustrates the sub-feeder circuit connection data entry processing algorithm 444 of the navigational and data entry process 400. The sub-feeder circuit algorithm 444 includes prompting 454 the user to enter, input or select the number of sub-feeder circuits connected to the feeder circuit. The prompt 454 may ask the user to enter the number of sub-feeder circuits, or ask the user to select the number of sub-feeder circuits from a menu or list. In one embodiment, user input selection values of 0 through 10 are made available for user selection of the number of sub-feeder circuits connected to the feeder circuit, although input or selection values greater than 10 may be used if desired.

If the number of sub-feeder circuits entered, input or selected by the user at step 454 is zero, the systems enters navigation logic 434 as explained below. If the number of sub-feeder circuits entered, input or selected by the user at step 454 is a non-zero value, the system proceeds to prompt the user to input, enter or select an overcurrent protection device for the sub-feeder circuit at step 456. At step 458, the system prompts the user to input, enter or select an “other device” for the feeder circuit, and also prompts the user to enter whether the branch circuit contains yet another device at step 460. If the user chooses to add another device at step 460, the system returns to step 458.

There are two basic types of devices for sub-feeder circuits represented in steps 456 and 458. Possible overcurrent protective devices for sub-feeder circuits to be entered, input or selected by the user at step 456 include Branch Circuit Fuses such as UL 448 Fuses in a Fuse holder such as a UL 512 Fuse holder; Circuit Breakers such as UL 489 Circuit Breakers; Fused Pullouts such as UL 1429 Pullout Switches with Branch Circuit Fuses such as UL 448 Fuses; and Fused Switches such as UL 98 Misc. Switches with Branch Circuit Fuses such as UL 448 Fuses.

Possible other devices for feeder circuits to be entered, input or selected by the user at step 458 include Bus Bar Systems; Magnetic Controllers including includes definite purpose, lighting, or HP rated contactors; molded Case Switches such as UL 489 Molded Case Switches; Non-Fused Switches such as UL 508 Manual Motor Controllers; Non-Fused Switches such as UL 98 Misc. Switches; Terminal Block-Power Distribution Blocks (Listed to UL 1953); Semiconductor Fuses (UL 448 Fuses) in Fuse holder (UL 512 Fuse holder); Silicon Control Rectifiers (UL508C); Terminal Blocks—Power Dist. Blocks (Recognized to UL 1059) with Feeder Circuit Spacing; Transformers (UL 506 or UL 1561); and Multi-Lug Terminals.

It is understood that the devices mentioned in reference to steps 456 and 458 are exemplary only, and that greater or fewer numbers of devices, including devices not listed above, may be entered, input or selected in other embodiments of the invention without limitation.

If the user does not choose to add another device at step 460 for the feeder circuit, the system prompts 462 the user to enter, input or select the number of branch circuits connected to the sub-feeder circuit. The prompt 462 may ask the user to enter the number of branch circuits connected to the sub-feeder circuit, or asks the user to select the number of branch circuits from a menu or list. In one embodiment, user input selection values of 0 through 10 are made available for user selection of the number of branch circuits connected to the sub-feeder circuit in the proposed panel being configured, although input or selection values greater than 10 may be used if desired.

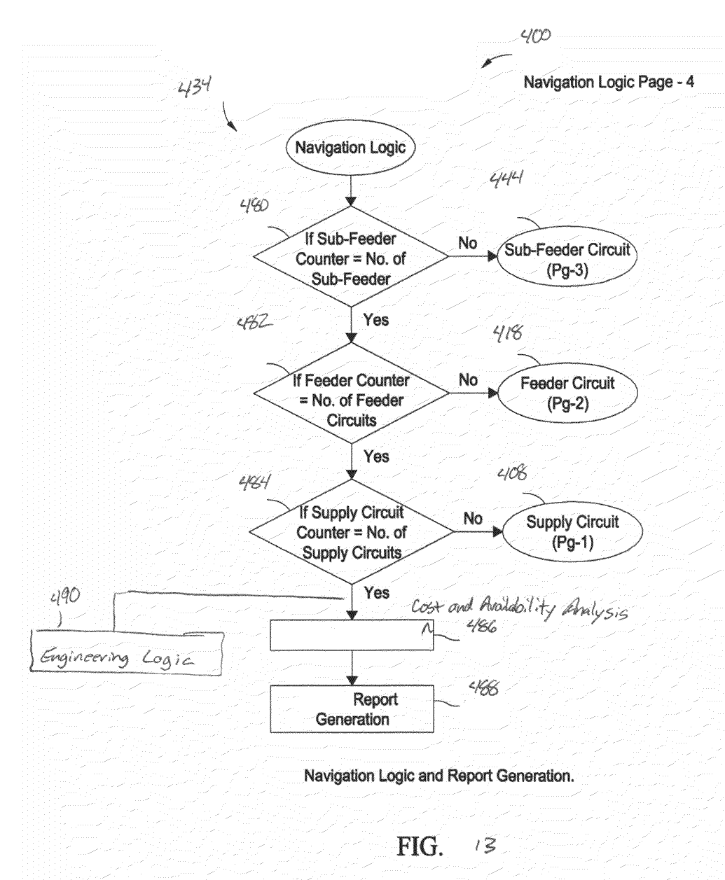

If the number of branch circuits entered, input or selected by the user at step 462 is zero, the systems enters 434 the navigation logic algorithm shown in FIG. 13. If the number of branch circuits entered, input or selected by the user at step 462 is a non-zero value, the system proceeds to prompt the user to input, enter or select an overcurrent protection device for the branch circuit at step 466. At step 468, the system prompts the user to input, enter or select an “other device” for the branch circuit, and also prompts the user to enter whether the branch circuit contains yet another device at step 470. If the user chooses to add another device at step 470, the system returns to step 468.

In one embodiment, the possible devices to be entered, input or selected by the user for the branch circuits at steps 466 and 468 may include any of the branch circuit devices described in relation to steps 420 and 422 of FIG. 10. While specific devices are described, it is understood that the devices for the branch circuits are exemplary only, and that other devices may be entered, input or selected by a user in another embodiment.

If the user does not choose to add another device at step 470, the system determines 472 whether the branch count obtained from step 462 equals the number of branch circuits entered into the system at steps 466 and 468. If the branch count is less than the number of branch circuits entered by the user, the system returns to step 466 for the next branch to be entered. If the branch count is equal to the number of branch circuits entered by the user, the system enters 434 the navigation logic algorithm.

Turning now to FIG. 13, the navigational logic algorithm 434 includes determining 480 whether the sub-feeder count obtained from step 454 in FIG. 12 is equal to the number of sub-feeder circuits entered into the system. If the sub-feeder count is less than the number of sub-feeder circuits entered into the system, the system returns to the sub-feeder circuit connection data entry processing algorithm 444.

If the sub-feeder count is equal to the number of sub-feeder circuits entered into the system, the system determines 482 whether the feeder count obtained from step 432 in FIG. 11 is equal to the number of feeder circuits entered into the system. If the feeder count is less than the number of feeder circuits entered into the system, the system returns to the feeder circuit connection data entry processing algorithm 418.

If the feeder count is equal to the number of feeder circuits entered into the system, the system determines 484 whether the supply circuit count obtained from step 406 in FIG. 10 is equal to the number of supply circuits entered into the system. If the supply circuit count is less than the number of supply circuits entered into the system, the system returns to the supply circuit data entry processing algorithm 402 at step 408.

By virtue of the steps 480, 482 and 484, the system is ensured of completely accounting for all circuits in the electrical panel and to account for all the circuits in the assessment or evaluation of the control panel. Human error associated with the failure to consider all the devices in all of the circuits in the panel is avoided.

If the supply circuit count at step 484 is equal to the number of supply circuits entered into the system, the panel 100 is now completely configured and all the data and information necessary to evaluate the proposed panel as configured has been obtained. While exemplary processes and component selections have been described, the invention is not necessarily limited to these specific algorithms or selections to configuring the electrical panel 100. For example, the panel 100 may be configured in ways apart from the circuits contained in the panel that may also be prompted by the system so that configuration data and information may be collected. For example, different types and/or different sizes of enclosures for the panel 100 are possible. Safety features such as barriers and covers for certain portions of the panel 100 are further possible and could be selected by a user to configure a panel. Certain types of spare fuses and holders therefore are likewise possible and may be selected by a system user. Further options and adaptations are possible as those in the art would no doubt understand that should be taken into account when evaluating and configuring proposed panels.

The data entry and navigational processes described above are further provided for purposes of illustration rather than limitation, and there are of course other ways that selection data and information could be presented or obtained by the system 150. The step-by-step option selection for configuring the panel, as guided by the system 100, significantly reduces, if not eliminates, opportunity for mistake, misinterpretation, or miscommunication that can, as discussed in detail above, delay and complicate any effort to obtain or provide a satisfactory panel to the user in a timely and efficient manner and at an agreed upon and acceptable cost.

While not apparent from the exemplary algorithms illustrated, it is contemplated that that panel configuration information obtained by the system may be stored on the system and later retrieved. When a user logs on and retrieves a previously configured panel, some or all of the data acquisition projects could be obviated for certain sessions with a user. Such storage and retrieval capability avoids the user having to re-enter or re-select some or all of previously selected options to configure a panel. This can be of great convenience for users who wish to retrieve and modify previously configured panel, rather than to configure an entirely new one.

It should be clear from the exemplary data entry processes described that, in view of the options available to configure a panel, tremendous variation in the end configuration of possible, as selected by different users, is not only possible but highly probable. As such, the panels 100 are not mass produced, commodity products, but are highly customized and rather complex products that are not subject to commodity pricing.

Once the necessary data and information concerning the configured panel has been obtained, the system 150 facilitates technical analysis and review of the panel 100 as configured to ensure that is meets the specifications desired, as well as analyzes 486 cost and availability information as discussed above. Additionally, the system generates 488 one or more detailed reports for analysis by the user, and also evaluates and identifies potential problems with the panel configuration by applying 490 engineering logic.

While the steps 486, 488 and 490 are shown at the conclusion of the data entry and selection processes, these steps can advantageously be performed at any time in the panel configuration process. In such an embodiment, the system 150 is capable of displaying cost information, or alternatively identifying engineering issues with a configured panel, at each step of the analysis as the component devices of the supply circuits, feeder circuits, sub-feeder circuits and associated branch circuits are entered, input or selected by the user. Display of such analysis at each step, upon demand by the user, provides feedback to the user at each step and provides some ability for the user to understand how certain devices impact the ultimate results obtained.

As a result, at any point in the panel configuration, the user may be provided with cost information for panel configuration, detailed cost information and reports, even for incomplete panel configurations. Also, at any time, and whether or not based on information provided by the system, the user may modify the panel configuration by adding options, removing options selected, or changing options previously selected.

It is therefore possible for systems users to obtain more or less real time pricing information for panels as they are being virtually designed and built with the system 150. System users may therefore compare how certain option selections affect the end cost of the panel(s) as they are created. Real time decision making is facilitated whether or not proposed panel configurations would be acceptable from a cost standpoint. Also as described, availability information for a proposed panel as configured is also provided with the cost information. Such real time feedback provides a wealth of information in an instant that previously was not possible to provide without a cumbersome, and typically manually performed, review process that involved a number of persons at different locations, and hence was prone to delay and human error.

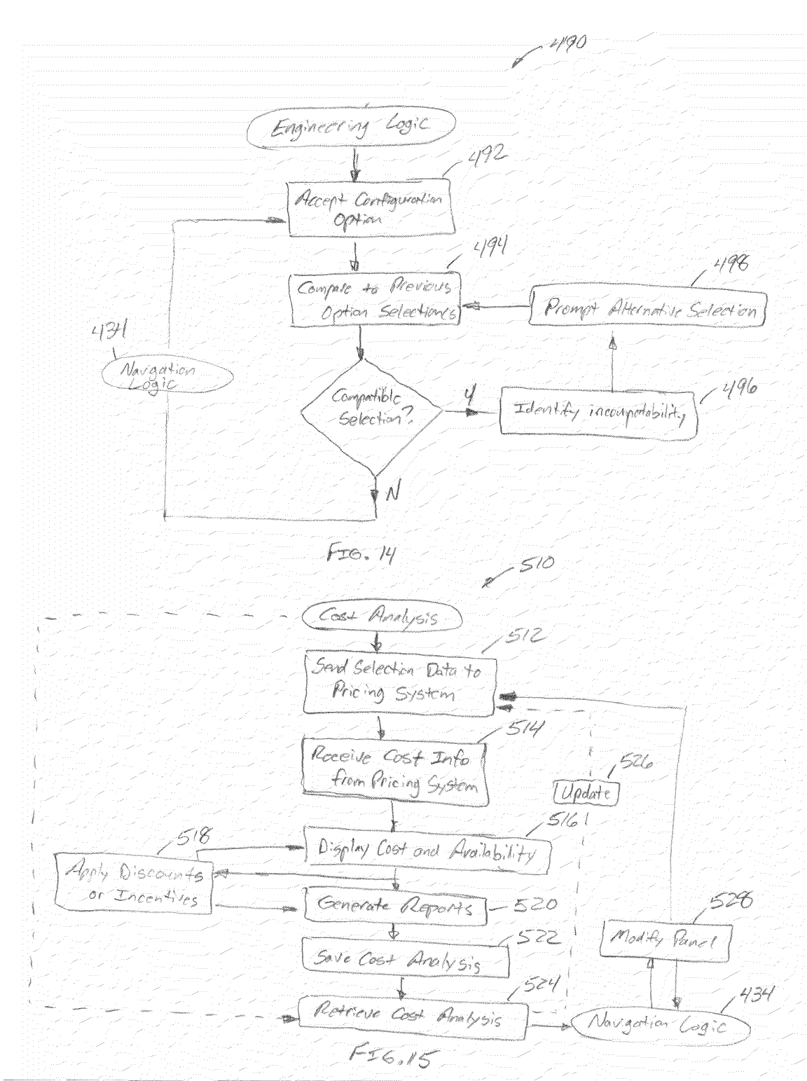

FIG. 14 illustrates an exemplary engineering logic algorithm 490 implemented in the system 150. As shown in FIG. 14, the algorithm includes 492 accepting a configuration option and comparing 494 the selected option to a previously selected option or previously selected options. The comparison may be, for example, a rule based comparison that if a given option x is selected then other given options y and/or z may not be selected due to technical incompatibility or undesirability from an engineering perspective. An example of an incompatible selection may be a circuit protector having an interrupting rating that is a mismatch for upstream or downstream components in the circuitry, although other incompatibilities are possible. Apart from circuit protector devices, other types of electrical components used in combination can be problematic for similar reasons or other reasons as those in the art would appreciate. The engineering logic, and specifically the comparison at step 494, is provided to identify and resolve such concerns.

If an engineering incompatibility or undesirability is detected, the system may identify 496 the incompatibility to the user and prompt 498 another selection. Once an alternative selection is made at step 498, the comparison of step 494 is again performed. The identification or notification at step 496 may include a brief explanation of the issue detected so that the user can more readily make an appropriate alternative selection.

If there is no incompatibility found in the option selected at step 492, the system may return to the navigation logic 434 or alternatively to accept another configuration option at step 492.

In different embodiments, the engineering logic could be applied with every option selection, in groups (e.g., as each circuit is complete) or for the entire panel once all the option selections are entered. Furthermore, the engineering logic may be automatically performed or applied by the system 150, or may alternatively may be performed only at the user's request.

FIG. 15 illustrates an exemplary cost and availability algorithm 510 for a configured product on the system 150. In the example shown, the algorithm 510 includes sending data and information for selected configuration operations to the pricing system 155 (FIGS. 2 and 3). The pricing system 155 retrieves cost information corresponding to the sent data and information, which are sent back to and received 514 by the system 150. The system 150, based on the received information, then displays cost and availability information for the configured panel. The communication with the pricing system 155 is generally transparent to the end user, but allows for accurate and up-to-date cost information to be quickly generated.

As shown in the exemplary screen display 244 (FIG. 4) the cost information may include a list price 236, and the availability information may include a projected availability of the completed panel. In the example of FIG. 4, the projected completion date is shown as 4-6 weeks. The projected completion date may be indicated with greater or lesser time intervals in different embodiments, or when possible, actual completion dates, delivery dates, and the like may be provided.

As shown at step 518, the system may further process any applicable discounts or incentives and include an adjusted price either in the display of step 516 or in a detailed report as shown at step 520. The discounts and incentives may be made available to all users, or may be user specific in various embodiments. When discounts or incentives are user-specific, they may be linked to user profiles, such that as users log on to the system 150, any availability of discounts or incentives may be automatically known by the system 150 for application. In the exemplary price quote shown in FIG. 9, an adjustment is shown in the form of a panel list price and a panel net price, with the net price including discounts and/or incentives. Other nomenclatures for such adjustments are possible and could be implemented. The date of generation of the quote is also included in the price quote shown in FIG. 9.

The cost information may be stored 522 by the system 150 and later retrieved 524 at a user's request. The retrieval of step 524 can be made in response to a user request of applicable search fields, such as any of those shown in the project detail section 202 of the screen display 200 (FIG. 4). Time intervals between storage and retrieval of the cost information may be hours, days, months or possibly years. If enough time has elapsed that the stored cost information has become stale, it can be updated as shown at step 526 by repeating steps 512 and 514 and again displayed at step 516 or reported at step 518. The updated cost information can itself be stored and retrieved at steps 522 and 524. The ability to recall previously provided cost information data can serve as a convenient, preliminary price indicator for comparable panels at different points in time.

The navigation logic 434 can be entered into from the cost analysis algorithm 510. From the navigation logic, a user can review the panel configuration in numerous levels of detail, modify the panel as shown at step 528, or configure a new panel if desired. Multiple panels can be configured, modified, and priced on the system 150 in a single session or in multiple sessions. When so authorized, different users may access the panel configuration data, including but not limited to cost, may modify existing panel configurations on the system, or otherwise work collaboratively to complete a satisfactory panel configuration at an acceptable cost.

The systems and processes described above are not limited to the specific embodiments described herein. Components of each system and each process can be practiced independent and separate from other components and processes described herein. Each component and process also can be used in combination with other components, systems and processes.

### IV. Conclusion

The benefits and advantages of the invention are now believed to be amply demonstrated in the various embodiments disclosed.

A method of cost estimating a proposed design of a product has been disclosed. The method is implemented in a computer system, and the method includes: accepting, with the computer system, data and information corresponding to the proposed design of the product, wherein the proposed design of the product is customized to user-defined specifications and includes a plurality of interconnected devices; applying, by the computer system, engineering logic to the accepted data and information as it is accepted; and presenting, with the computer system, estimated cost information and estimated availability information for the proposed design based on the accepted data and information.

Optionally, the method may further include presenting the analysis information in a screen display, the screen display including a price date. The screen display may further include a user selectable option to modify the proposed design. The method may also include generating at least one of a detailed bill of materials and cost quote and an approval drawing.

The product may be a configurable electrical control panel, and the method may include accepting data and information corresponding to configurable options in the electrical panel. The electrical control panel may include circuit protector devices, and the method may include accepting data and information corresponding to user selected circuit protector devices. The electrical control panel may be configurable with a user selected number of circuits selected from the group of: a supply circuit to the panel, a branch circuit connected to a supply circuit, a feeder circuit connected to a supply circuit, a branch circuit connected to feeder circuits, a sub-feeder circuit, a branch circuit connected to sub-feeder circuits and combinations thereof; and the method may include accepting data and information for the user selected number of circuits. Each of the user selected number of circuits may include user selected electrical components.

Applying engineering logic to the accepted data and information as it is accepted may include identifying incompatible user selected options, prompting the user to correct the incompatibility.

The method may optionally include communicating with a separately provided computer system to obtain cost information for the proposed design. Such communication may include: sending data and information for the proposed design to the separately provided computer system; and receiving cost data and information for the proposed design from the separately provided computer system.

The method may optionally include prompting selection of the data and information to a user and retrieving previously estimated cost information for the proposed design. The cost information may include a list price, and the method may further include: applying applicable discounts or incentives to the list price; and presenting a net purchase price including the applicable discounts or incentives.

An embodiment of a system for estimating cost of a proposed electrical product design configured with a user selected number of circuits having interconnected electrical circuit devices has been disclosed. The system includes: a computer system configured to: accept device data and information corresponding to eligible circuit devices to configure an electrical product; receive user provided data and information regarding a proposed electrical product configured to user defined specifications; selectively present the device data and information to a user based on the received user provided data and information for the proposed electrical product; analyze cost and availability of the proposed electrical product; and display a result of the analyzed cost and availability of the proposed electrical product.

Optionally, the computer system may be a network based system comprising: a client system comprising a browser; a database for storing information; and a server system adapted to be coupled to the client system and the database, the server being configured to implement the method.

The computer system may be adapted to analyze user selected device and data information for engineering compatibility, and when selected device and data information is incompatible, prompt the user to select alternative devices. The computer system may be adapted to present the cost and availability information in a screen display, the screen display including a price date. The computer system may be adapted to store the cost information and price date, and retrieve the cost information and price date for subsequent presentation to a user.

The computer system may be adapted to present information in a screen display, and the screen display may include a circuit layout selector for the electrical product, or a user selectable option to modify the proposed design. The computer system may be adapted to generate at least one of a detailed cost report for the product and an approval drawing. The proposed electrical product includes plurality of interconnected devices in a user selected number of circuits, the number of circuits being selectable from the group of: a supply circuit, a branch circuit connected to the supply circuit, a feeder circuit connected to the supply circuit, a branch circuit connected to the feeder circuit, a sub-feeder circuit, or a branch-circuit connected to the sub-feeder circuit. The plurality of interconnected devices may include overcurrent protection devices.

The computer system may be adapted to communicate with a separately provided computer system to obtain cost information for the proposed product. The computer system may further be adapted to: send data and information for the proposed design to the separately provided computer system; and based on the sent data and information, receive cost data and information for the proposed design from the separately provided computer system.

The computer system may be adapted to prompt selection of the data and information to a user. The cost information may include a list price, and the computer system may further be configured to: apply applicable discounts or incentives to the list price; and present a net purchase price including the applicable discounts or incentives.

An embodiment of a network-based system for pricing a proposed custom design of a configurable electrical control panel having a use selected number of interconnected circuits and circuit devices has also been disclosed. The circuits include at least one of a feeder circuit connected to a supply circuit, a branch circuit connected to the supply circuit, a sub-feeder circuit, and a branch circuit connected to the sub-feeder circuit, wherein each of the circuits includes an overcurrent protection device and another device. The system includes: a client system comprising a browser; a database for storing information; and a server system adapted to be coupled to the client system and the database. The server is further adapted to: accept device data and information corresponding to eligible overcurrent protection devices and other devices for configuring electrical control panels; receive user provided data and information regarding a proposed control panel configured to user defined specifications; selectively present device data and information to a user based on previously received user provided data and information for the proposed panel; apply engineering logic to identify incompatible devices as they are selected; analyze cost and availability of the proposed product; and display a result of the analyzed cost and availability.

The overcurrent protection devices may include at least one or more of a fused pullout device, a pullout switch, a fused switch, a circuit breaker, a combination starter, a branch circuit fuse, and combinations thereof. The server may be further adapted to, when a selected device and data information is incompatible with a previously selected device, prompt the user to select an alternative device. The server is further adapted to store the cost information and price date, and retrieve the cost information and price date for subsequent presentation to a user. The server is adapted to generate at least one of a detailed cost quote for the electrical control panel and an approval drawing. The server is adapted to communicate with a separately provided computer system to obtain cost information for the proposed product, and the server is further adapted to: send data and information for the proposed design to the separately provided computer system; and based on the sent data and information, receive cost data and information for the proposed design from the separately provided computer system.

The server may further be adapted to prompt selection of the data and information to a user. The cost information may include a list price, and the server is further configured to: apply applicable discounts or incentives to the list price; and present a net purchase price including the applicable discounts or incentives.

An embodiment of a computer program embodied on a non-transitional computer readable medium for evaluating and assessing cost and availability of a proposed electrical panel configured to user defined specifications is also disclosed. The program includes at least one code segment for instructing a computer that receives user provided selections for proposed devices in a configured electrical panel, and, in response to the received selections; when each selection is received, analyze the selections for engineering compatibility with other selected devices in the configured electrical panel; determine cost and projected availability information for the configured electrical panel; and display cost and availability information of the configured electrical panel for inspection by a user.

The program may further include at least one code segment that displays a price date; at least one code segment that displays a product layout section for the proposed electrical panel; and/or at least one code segment prompting selection of another device when an engineering incompatibility is identified.

The program may further include: at least one code segment that sends information based on the user provided selections to a separately provided, computer implemented pricing system; and at least one code segment that receives information, based on the user provided selection, from the separately provided, computer implemented pricing system.

The program may also include at least one code segment configured to retrieve previously displayed cost information for the proposed electrical panel; and/or at least one code segment configured to apply any applicable discounts or incentives and display a net price including the applicable discounts or incentives.

An embodiment of an electronic system for evaluating cost and availability information for a customized electrical product including multiple, user selected interconnected circuits and circuit devices is disclosed. The system includes: means for storing data and information relating to eligible circuit devices for the interconnected circuits; means for receiving user provided circuit device selections; means for analyzing an engineering compatibility of selected circuit devices; and means for providing cost and projected availability information for the customized electrical device as configured by the user.

The means for storing installation data may comprise a database. The means for receiving may comprise a network-based system. The means for displaying comprises a computer program embodied on a computer readable medium. The means for communicating may comprise a display screen. The circuits may include overcurrent protection devices and other devices.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of cost estimating a proposed design of a product, the method implemented in a computer system, the method comprising:
accepting, with the computer system, data and information corresponding to the proposed design of the product, wherein the proposed design of the product is customized to user-defined specifications and includes a plurality of interconnected devices;
applying, by the computer system, engineering logic to the accepted data and information as it is accepted; and
presenting, with the computer system, estimated cost information and estimated availability information for the proposed design based on the accepted data and information.

2. The method of claim 1, further comprising presenting the analysis information in a screen display, the screen display including a price date.

3. The method of claim 2, the screen display further comprising a user selectable option to modify the proposed design.

4. The method of claim 1, further comprising generating at least one of a detailed bill of materials and cost quote and an approval drawing.

5. The method of claim 1, wherein the product is a configurable electrical control panel, and the method comprises accepting data and information corresponding to configurable options in the electrical panel.

6. The method of claim 5, wherein the electrical control panel includes circuit protector devices, and the method includes accepting data and information corresponding to user selected circuit protector devices.

7. The method of claim 6, wherein the electrical control panel is configurable with a user selected number of circuits selected from the group of: a supply circuit to the panel, a branch circuit connected to a supply circuit, a feeder circuit connected to a supply circuit, a branch circuit connected to feeder circuits, a sub-feeder circuit, a branch circuit connected to sub-feeder circuits and combinations thereof; and
the method comprises accepting data and information for the user selected number of circuits.

8. The method of claim 7, wherein each of the user selected number of circuits includes user selected electrical components.

9. The method of claim 1, wherein applying engineering logic to the accepted data and information as it is accepted comprises identifying incompatible user selected options.

10. The method of claim 19, further comprising prompting the user to correct the incompatibility.

11. The method of claim 1, further comprising communicating with a separately provided computer system to obtain cost information for the proposed design.

12. The method of claim 11, wherein communicating with the separately provided computer system comprises:
sending data and information for the proposed design to the separately provided computer system; and
receiving cost data and information for the proposed design from the separately provided computer system.

13. The method of claim 1, further comprising prompting selection of the data and information to a user.

14. The method of claim 1, further comprising retrieving previously estimated cost information for the proposed design.

15. The method of claim 1, wherein the cost information includes a list price, and the method further comprises:
applying applicable discounts or incentives to the list price; and
presenting a net purchase price including the applicable discounts or incentives.

16. A system for estimating cost of a proposed electrical product design configured with a user selected number of circuits having interconnected electrical circuit devices, the system comprising:
a computer system configured to:
accept device data and information corresponding to eligible circuit devices to configure an electrical product;
receive user provided data and information regarding a proposed electrical product configured to user defined specifications;
selectively present the device data and information to a user based on the received user provided data and information for the proposed electrical product;
analyze cost and availability of the proposed electrical product; and
display a result of the analyzed cost and availability of the proposed electrical product.

17. The system of claim 16 wherein the computer system is a network based system comprising:
a client system comprising a browser;
a database for storing information; and
a server system adapted to be coupled to the client system and the database, the server being configured to implement the method.

18. The system of claim 16, the computer system further adapted to analyze user selected device and data information for engineering compatibility, and when selected device and data information is incompatible, prompt the user to select alternative devices.

19. The system of claim 16, the computer system further adapted to present the cost and availability information in a screen display, the screen display including a price date.

20. The system of claim 19, wherein the computer system is further adapted to store the cost information and price date, and retrieve the cost information and price date for subsequent presentation to a user.

21. The system of claim 16, wherein the computer system is further adapted to present information in a screen display, and the screen display comprises a circuit layout selector for the electrical product.

22. The system of claim 16, wherein the computer system is further adapted to present information in a screen display, and wherein the screen display comprises a user selectable option to modify the proposed design.

23. The system of claim 16, wherein the computer system is adapted to generate at least one of a detailed cost report for the product and an approval drawing.

24. The system of claim 16, wherein the proposed electrical product includes plurality of interconnected devices in a user selected number of circuits, the number of circuits being selectable from the group of: a supply circuit, a branch circuit connected to the supply circuit, a feeder circuit connected to the supply circuit, a branch circuit connected to the feeder circuit, a sub-feeder circuit, or a branch-circuit connected to the sub-feeder circuit.

25. The system of claim 24, wherein the plurality of interconnected devices includes overcurrent protection devices.

26. The system of claim 16, wherein the computer system is adapted to communicate with a separately provided computer system to obtain cost information for the proposed product.

27. The system of claim 26, wherein the computer system is further adapted to:
send data and information for the proposed design to the separately provided computer system; and
based on the sent data and information, receive cost data and information for the proposed design from the separately provided computer system.

28. The system of claim 16, the computer system further adapted to prompt selection of the data and information to a user.

29. The system of claim 16, wherein the cost information includes a list price, and the computer system is further configured to:
apply applicable discounts or incentives to the list price; and
present a net purchase price including the applicable discounts or incentives.

30. A network-based system for pricing a proposed custom design of a configurable electrical control panel having a use selected number of interconnected circuits and circuit devices, the circuits including at least one of a feeder circuit connected to a supply circuit, a branch circuit connected to the supply circuit, a sub-feeder circuit, and a branch circuit connected to the sub-feeder circuit, wherein each of the circuits includes an overcurrent protection device and another device,
the system comprising:
a client system comprising a browser;
a database for storing information; and
a server system adapted to be coupled to the client system and the database, the server further adapted to:
accept device data and information corresponding to eligible overcurrent protection devices and other devices for configuring electrical control panels;
receive user provided data and information regarding a proposed control panel configured to user defined specifications;
selectively present device data and information to a user based on previously received user provided data and information for the proposed panel;
apply engineering logic to identify incompatible devices as they are selected;
analyze cost and availability of the proposed product; and
display a result of the analyzed cost and availability.

31. The system of claim 30, wherein the overcurrent protection devices include at least one or more of a fused pullout device, a pullout switch, a fused switch, a circuit breaker, a combination starter, a branch circuit fuse, and combinations thereof.

32. The system of claim 30, wherein the server is further adapted to, when a selected device and data information is incompatible with a previously selected device, prompt the user to select an alternative device.

33. The system of claim 30, wherein the server is further adapted to store the cost information and price date, and retrieve the cost information and price date for subsequent presentation to a user.

34. The system of claim 30, wherein the server is adapted to generate at least one of a detailed cost quote for the electrical control panel and an approval drawing.

35. The system of claim 30, wherein the server is adapted to communicate with a separately provided computer system to obtain cost information for the proposed product.

36. The system of claim 36, wherein the server is further adapted to:
send data and information for the proposed design to the separately provided computer system; and
based on the sent data and information, receive cost data and information for the proposed design from the separately provided computer system.

37. The system of claim 30, the server further adapted to prompt selection of the data and information to a user.

38. The system of claim 30, wherein the cost information includes a list price, and the server is further configured to:
apply applicable discounts or incentives to the list price; and
present a net purchase price including the applicable discounts or incentives.

39. A computer program embodied on a non-transitional computer readable medium for evaluating and assessing cost and availability of a proposed electrical panel configured to user defined specifications, the program comprising at least one code segment for instructing a computer that receives user provided selections for proposed devices in a configured electrical panel, and, in response to the received selections;
when each selection is received, analyze the selections for engineering compatibility with other selected devices in the configured electrical panel;
determine cost and projected availability information for the configured electrical panel; and
display cost and availability information of the configured electrical panel for inspection by a user.

40. The program of claim 39, further comprising at least one code segment that displays a price date.

41. The program of claim 39, further comprising at least one code segment that displays a product layout section for the proposed electrical panel.

42. The program of claim 39, further comprising at least one code segment prompting selection of another device when an engineering incompatibility is identified.

43. The program of claim 39, further comprising:
at least one code segment that sends information based on the user provided selections to a separately provided, computer implemented pricing system; and
at least one code segment that receives information, based on the user provided selection, from the separately provided, computer implemented pricing system.

44. The program of claim 39, further comprising at least one code segment configured to retrieve previously displayed cost information for the proposed electrical panel.

45. The program of claim 39, further comprising at least one code segment configured to apply any applicable discounts or incentives and display a net price including the applicable discounts or incentives.

46. An electronic system for evaluating cost and availability information for a customized electrical product including multiple, user selected interconnected circuits and circuit devices, the system comprising:
means for storing data and information relating to eligible circuit devices for the interconnected circuits;
means for receiving user provided circuit device selections;
means for analyzing an engineering compatibility of selected circuit devices; and
means for providing cost and projected availability information for the customized electrical device as configured by the user.

47. The system of claim 46 wherein the means for storing installation data comprises a database.

48. The system of claim 46 wherein the means for receiving comprises a network-based system.

49. The system of claim 46 wherein the means for displaying comprises a computer program embodied on a computer readable medium.

50. The system of claim 46 wherein the means for communicating comprises a display screen.

51. The system of claim 46 wherein the circuits comprise overcurrent protection devices and other devices.
